(19) United States
(12) Patent Application Publication
(10) Pub. No.: US 2025/0024315 A1
(43) Pub. Date: Jan. 16, 2025

(54) MEDIA SERVICES UTILIZING NETWORK SLICING WITH USER AND DEVICE PROFILES

(71) Applicant: Samsung Electronics Co., Ltd., Suwon-si (KR)

(72) Inventor: Prakash Reddy Kolan, Plano, TX (US)

(21) Appl. No.: 18/765,068

(22) Filed: Jul. 5, 2024

Related U.S. Application Data
(60) Provisional application No. 63/526,876, filed on Jul. 14, 2023.
(60) Provisional application No. 63/548,056, filed on Nov. 10, 2023.

(51) Int. Cl. H04W 28/02; H04W 48/16; H04W 48/18

(52) U.S. Cl. CPC H04W 28/0268; H04W 48/16; H04W 48/18

(57) ABSTRACT

A method includes providing first application flows related to a first application instance via a first device profile, wherein the first device profile corresponds to a first network slice. The method also includes identifying that a quality of service (QOS) required for the first application flows is not met by the first device profile. The method further includes, in response to identifying that the QoS required for the first application flows is not met, selecting a second device profile corresponding to a second network slice based on (i) a capability of the second device profile to provide the QoS required for the first application flows and (ii) a presence of a second application instance corresponding to the first application instance. In addition, the method includes migrating at least one of the first application flows from the first device profile to the second device profile.

### CROSS-REFERENCE TO RELATED APPLICATION AND PRIORITY CLAIM

This application claims priority under 35 U.S.C. § 119 (e) to U.S. Provisional Patent Application No. 63/526,876 filed on Jul. 14, 2023 and U.S. Provisional Patent Application No. 63/548,056 filed on Nov. 10, 2023, which are hereby incorporated by reference in its entirety.

### TECHNICAL FIELD

This disclosure relates generally to multimedia devices and processes. More specifically, this disclosure relates to media services with network slicing and user and device profiles.

### BACKGROUND

Network slicing is one of the technologies that is being supported in next generation 5G networks. With network slicing, differentiated quality, experience, and isolation can be provided to end users of 5G services. Even though the concept of network slicing has been in works since the last stages of 4G networks, no support of network slicing was available in any devices in the 3GPP domain including the UE terminals, network devices, and application servers. With increased 5G speeds, UE vendors are adding support for network slicing slowly. Android and IOS have started supporting network slicing in a simpler form. Capabilities and procedures have to be standardized and implemented for wide support of network slicing with next generation services.

### SUMMARY

This disclosure provides media services with network slicing and user and device profiles.

In a first embodiment, a method includes providing first application flows related to a first application instance via a first device profile, wherein the first device profile corresponds to a first network slice. The method also includes identifying that a quality of service (QOS) required for the first application flows is not met by the first device profile. The method further includes, in response to identifying that the QoS required for the first application flows is not met, selecting a second device profile corresponding to a second network slice based on (i) a capability of the second device profile to provide the QoS required for the first application flows and (ii) a presence of a second application instance corresponding to the first application instance. In addition, the method includes migrating at least one of the first application flows from the first device profile to the second device profile.

In a second embodiment, an application function includes a transceiver and a processor. The processor is configured to provide first application flows related to a first application instance via a first device profile, wherein the first device profile corresponds to a first network slice. The processor is also configured to identify that a quality of service (QOS) required for the first application flows is not met by the first network slice. The processor is further configured to in response to identifying that the QoS required for the first application flows is not met, select a second device profile corresponding to a second network slice based on (i) a capability of the second device profile to provide the QoS required for the first application flows and (ii) a presence of a second application instance corresponding to the first application instance. In addition, the processor is configured to migrate at least one of the first application flows from the first device profile to the second device profile.

In a third embodiment, a user equipment includes a transceiver and a processor. The processor is configured to provide first application flows related to a first application instance via a first device profile, wherein the first device profile corresponds to a first network slice. The processor is also configured to identify that a quality of service (QOS) required for the first application flows is not met by the first device profile. The processor is further configured to, in response to identifying that the QoS required for the first application flows is not met, select a second device profile corresponding to a second network slice based on (i) a capability of the second device profile to provide the QoS required for the first application flows and (ii) a presence of a second application instance corresponding to the first application instance. In addition, the processor is configured to transmit a message to an application function to migrate at least one of the first application flows from the first device profile to the second device profile.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system 100 in accordance with an embodiment of this disclosure;

FIGS. 2 and 3 illustrate example electronic devices in accordance with an embodiment of this disclosure;

FIG. 4 illustrates a network slicing architecture in accordance with this disclosure;

FIG. 5 illustrates an example system where different networks slices are used for different user profiles in accordance with this disclosure;

FIG. 6 illustrates an example architecture for 5G media streaming in accordance with this disclosure;

FIG. 7 illustrates an example system that uses a secondary slice for outbound M5 requests in accordance with this disclosure;

FIG. 8 illustrates an example system for migration of media flow if a current network slice cannot provide sufficient QoS in accordance with this disclosure;

FIG. 9 illustrates an example system for stream splitting between multiple app instances for service continuity in accordance with this disclosure;

FIG. 10 illustrates an example system for network-initiated app switching in accordance with this disclosure;

FIG. 11 illustrates an example system for UE-initiated app switching in accordance with this disclosure;

FIG. 12 illustrates an example method for optimizing the media service performance according to this disclosure;

FIG. 13 illustrates an example system for use of secondary slice for outbound M5 request based on an AF recommendation in accordance with this disclosure;

FIG. 14 illustrates an example system for network assistance information for all network slices in accordance with this disclosure;

FIGS. 15A and 15B illustrate an example call flow for bootstrapping application invocation on a network slice according to this disclosure;

FIG. 16 illustrates an example system downlink media streaming with AF and AS in the trusted data network with network slicing in accordance with this disclosure;

FIG. 17 illustrates an example system for downlink media streaming with AF and AS in an external data network (OTT) with network slicing in accordance with this disclosure;

FIG. 18 illustrates an example system for downlink media streaming with AFs in two trusted data networks sharing AS in external data network with network slicing in accordance with this disclosure;

FIG. 19 illustrates an example system for downlink media streaming with AF and AS in external data network delivering through two trusted data networks (OTT) with network slicing in accordance with this disclosure;

FIG. 20 illustrates an example system for downlink media streaming with AS in external data network accessible through two different network slices in accordance with this disclosure;

FIG. 21 illustrates an example system for downlink media streaming with AS deployed in multiple trusted data networks in accordance with this disclosure;

FIG. 22 illustrates an example system using a network slice for all application in the enterprise UE in accordance with this disclosure;

FIG. 23 illustrates an example system using a network slice for enterprise profile applications in accordance with this disclosure;

FIG. 24 illustrates an example system using a network slice for specific applications for enterprise users in accordance with this disclosure;

FIG. 25 illustrates an example system using a network slice for specific applications for all users in accordance with this disclosure; and

FIG. 26 illustrates an example method for media services with network slicing and user and device profiles.

### DETAILED DESCRIPTION

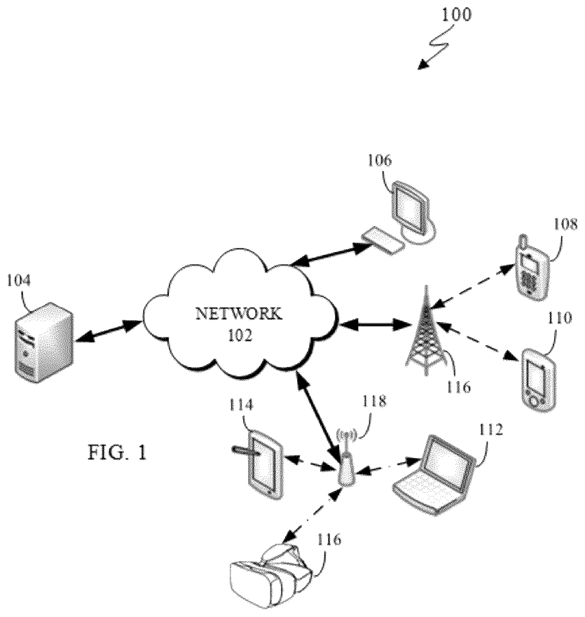

FIGS. 1 through 26, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

5G network slicing is becoming mainstream with many network operators performing trials to offer differentiated services to end users. In addition, UE OSes (Android, IOS) have started supporting network slicing capabilities in end user devices. An ecosystem is being developed where UE application developers have the facilities to request access to one or more network slices on the UE device so their application traffic get required traffic treatment. UE OS developers are supporting network slicing at different levels (user level, profile level, individual app level). With this, UE developers are being provided with enhanced capabilities to use network slicing as a feature they can exploit to give better user experience to end users at different levels. End-to-end mechanisms have to be developed so end user applications can use the optimal benefit of network slicing capabilities.

Android and IOS has started support of 5G network slicing in their UE implementations. Concept of user and device profiles tied to different network slices is being adopted. Enterprise consumers may have an enhanced network and service experience if an enterprise profile in the UE device connects to the network service rather than through the regular user profile. With different profile capabilities, it becomes possible that differentiated experiences may be delivered to apps in one profile over the other. There is also support for having the apps installed on more than one user profile. This disclosure provides methods for media service experience optimization to the end user by using apps installed in different user and device profiles.

While network slicing as a feature is being developed in the 5G network and end user device operating systems, gaps exist to use network slicing as a capability for end user applications. It is not clear how end user applications discover and identify suitable one or more network slices on the device to get required traffic treatment for traffic generated by the application. Network slices are not permanently reliable resources. Studies have shown that performance of network slices may suffer from time to time. In this context, it becomes imperative that whatever network slices that the UE applications discover, and use are able to provide reliability and quality requirements for the applications. Further, mechanisms have to be in place if the discovered and identified network slices do not perform according to expectations. This disclosure describes aspects related to discovery of appropriate network slices for end user applications, and mechanisms to continue operation if those network slices have artifacts from time to time.

The disclosure describes aspects related to optimization of media service experience by utilizing one or more app instances with different network capabilities due to network slicing; maintaining the quality of media streaming sessions during faulty network conditions; bootstrapping application invocation to a specific network slice by application on the UE; and collaboration scenarios and deployment options for next generation media services with network slicing. Some novel features described include UE and network initiated migration of media streaming sessions to apps in different user/device profiles for optimum service experience; methods for switching and splitting of applications flows of a media session to or between multiple app instances in different user/device profiles; methods for discovering appropriate network slice for 5G media service operations by the UE application with one or more device profiles; and developing network slice descriptor information from UE application for discovery and continuous operation even in presence of network slice artifacts.

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included a given device is increasing. Even with the increase of processing power portable electronic devices often struggle to provide the processing capabilities to handle new services and applications, as newer services and applications often require more resources that is included in a portable electronic device. Improved methods and apparatus for configuring and deploying media processing in the network is required.

Cloud media processing is gaining traction where media processing workloads are setup in the network (e.g., cloud) to take advantage of advantages of the benefits offered by the cloud such as (theoretically) infinite compute capacity, auto-scaling based on need, and on-demand processing. An end user client can request a network media processing provider for provisioning and configuration of media processing functions as required.

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

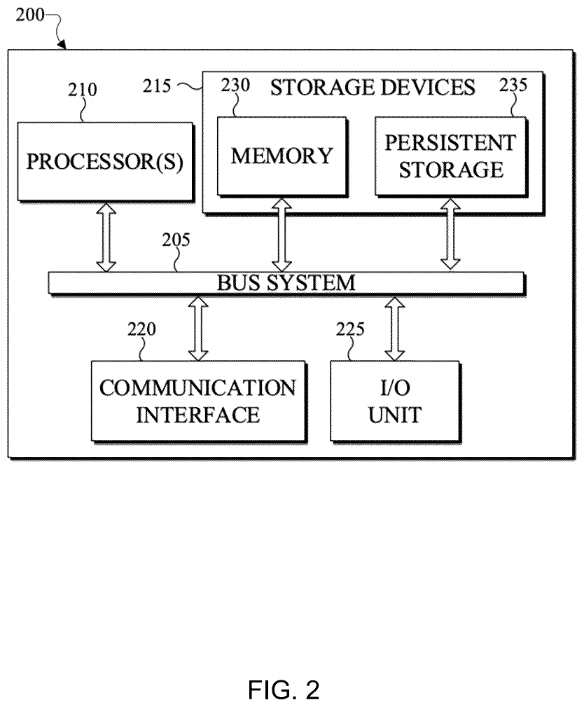

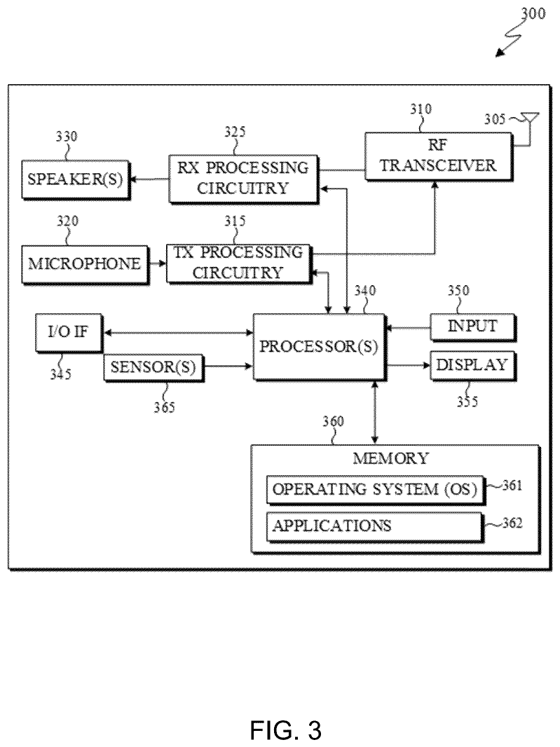

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

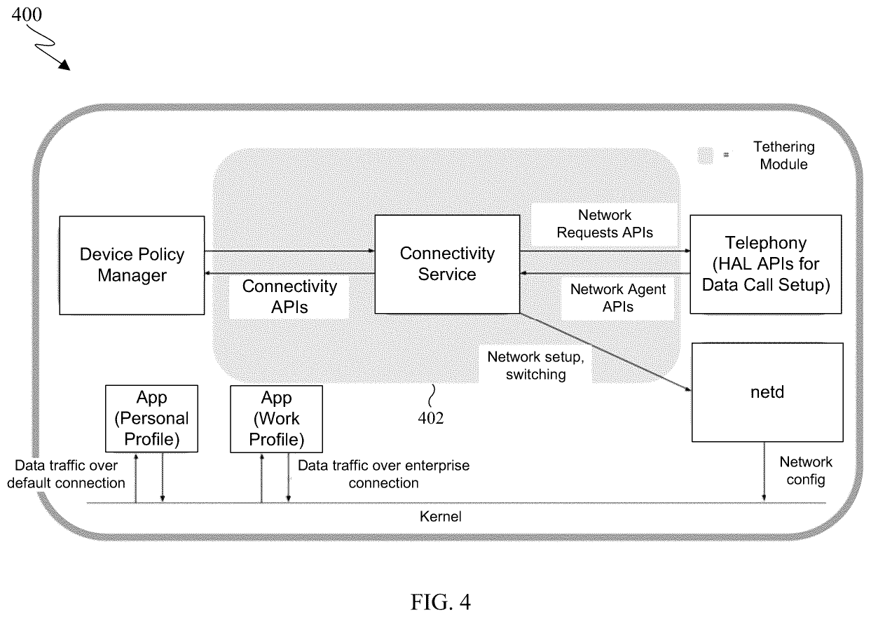

FIG. 4 illustrates an example network slicing architecture 400 in accordance with this disclosure. The embodiment of the network slicing architecture 400 illustrated in FIG. 4 is for illustration only. FIG. 4 does not limit the scope of this disclosure to any particular implementation of an electronic device.

As shown in FIG. 4, architecture 400 can support 5G network slicing mainly targeting enterprise customers. Architecture 400 can support 5G network slicing through additions to the telephony codebase in the Android Open Source Project (AOSP) and tethering module 402 to incorporation existing connectivity application programming interfaces (API) s that are required for network slicing. The architecture 400 can provide HAL and telephony APIs to support network slicing based on network requests filed by the core networking code and 5G slicing capabilities in the modem.

The support for 5G network slicing can be based on user or device profiles in the UE. One or more user or device profiles can be installed or setup in the system, and architecture 400 can provide capabilities for transferring traffic of all applications installed in a user or device profile to be transported over a separate network slice.

Although FIG. 4 illustrates a network slicing architecture 400, various changes may be made to FIG. 4. For example, the number and placement of various components of the network slicing architecture 400 can vary as needed or desired. In addition, the network slicing architecture 400 may be used in any other suitable multimedia process and is not limited to the specific processes described above.

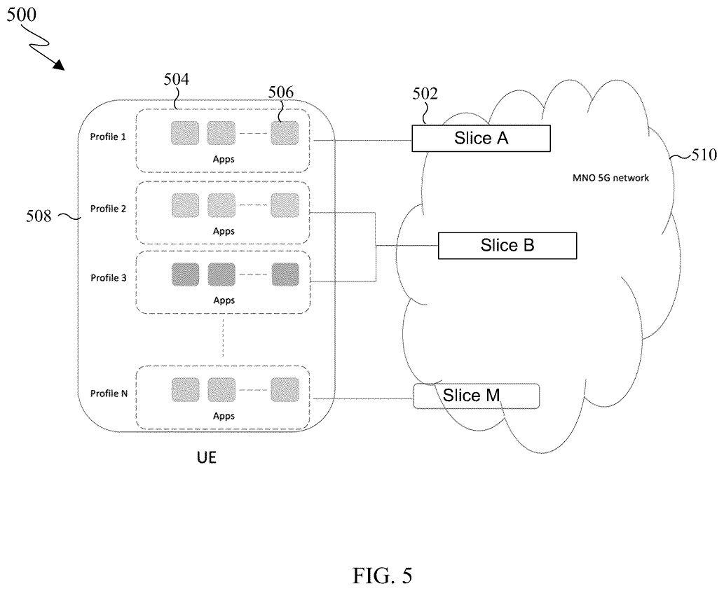

FIG. 5 illustrates an example system 500 where different networks slices 502 are used for different user profiles 504 in accordance with this disclosure. The embodiment of the system 500 illustrated in FIG. 5 is for illustration only. FIG. 5 does not limit the scope of this disclosure to any particular implementation of an electronic device.

As shown in FIG. 5, application traffic of apps 506 installed in one or more user/device profiles 504 in the UE 508 are transferred over a separate network slice 502. It is possible that a separate network slice 502 is provisioned by the MNO network 510 and used by the UE 508 for one user/device profile 504 (example Profile 1 in FIG. 5). Alternatively, apps 506 installed in one or more user or device profiles 504 can access the same network slice 502, and thus the traffic from those apps 506 are transferred over the same network slice 502 (example apps 506 in Profile 2 and Profile 3 use the same network slice 502).

Routing of application traffic between different network slices 502 for different profiles 504 can be performed using carrier configured URSP rules. Network carriers configure URSP rules for each network slice traffic with the traffic descriptor component of “IS Id+OS App Id type”.

Table 1 shows different OSAppId values for different slice categories in an operating system. These OSAppId values can be combined with OSId values to construct the traffic descriptor component.

TABLE 1

| Slice Category | OSAppld | Description |
|---|---|---|
| ENTERPRISE | 0x454E5445525052495345 | The OSAppld is a byte |
| | | array representation |
| | | of the string |
| | | “ENTERPRISE” |
| ENTERPRISE2 | 0x454E544552505249534532 | The OSAppld is a byte |
| | | array representation |
| | | of the string |
| | | “ENTERPRISE2” |
| ENTERPRISE3 | 0x454E544552505249534533 | The OSAppld is a byte |
| | | array representation |
| | | of the string |
| | | “ENTERPRISE3” |
| ENTERPRISE4 | 0x454E544552505249534534 | The OSAppld is a byte |
| | | array representation |
| | | of the string |
| | | “ENTERPRISE4” |
| ENTERPRISE5 | 0x454E544552505249534535 | The OSAppld is a byte |
| | | array representation |
| | | of the string |
| | | “ENTERPRISE5” |
| CBS | 0x434253 | The OSAppld is a byte |
| | | array representation |
| | | of the string “CBS” |
| PRIORITIZE_{—} | 0x5052494f524954495a455f4c4154454e43559 | The OSAppld is a byte |
| LATENCY | | array representation |
| | | of the string |
| | | “PRIORITIZE_LATENCY” |
| PRIORITIZE_{—} | 0x5052494f52494495a455f42414e445749445448 | The OSAppld is a byte |
| BANDWIDTH | | array representation |
| | | of the string |
| | | “PRIORITIZE_BANDWIDTH” |

Tables 2 and 3 show example URSP rules configured by the network operator for two different traffic categories—ENTERPRISE1 and ENTERPRISE2.

TABLE 2
URSP rule #1 (enterprise1)

| | |
|---|---|
| Precedence | 1 (0x01) |

Traffic descriptor #1

| | |
|---|---|
| OS Id + OS App | 0x97A498E3FC925C9489860333D06E4E470A454E5445525052495345 |
| Id type | |

Route selection descriptor #1

| | |
|---|---|
| Precedence | 1(0x01) |
| Component #1: | SST:XX SD:YYYYYY |
| S-NSSAI | |
| Component #2: | Enterprise |
| DNN | |

Route selection descriptor #2

| | |
|---|---|
| Precedence | 2(0x02) |
| Component #1: | enterprise |
| DNN | |

TABLE 3
URSP rule #2 (enterprise2)

| | |
|---|---|
| Precedence | 2 (0x02) |

Traffic Descriptor

| | |
|---|---|
| OS Id + OS App | 0x97A498E3FC925C9489860333D06E4E470B454E544552505249534532 |
| Id type | |

Route selection descriptor #1

| | |
|---|---|
| Precedence | 1 (0x01) |
| Component #1: | SST:XX SD:YYYYYY |
| S-NSSAI | |
| Component #2: | enterprise2 |
| DNN | |

Route selection descriptor #2

| | |
|---|---|
| Precedence | 2 (0x02) |
| Component #1: | enterprise2 |
| DNN | |

By configuring URSP rules separately for different categories, network operator facilitates differential traffic treatment for applications corresponding to those traffic categories. By tying traffic categories to different user or device profiles 504 in the UE 508, differential traffic treatment can be provided to apps 506 installed in different user or device profiles 504 in the UE 508.

Recently other operating systems added support for 5G network slicing. The other operating systems offer organizations the ability to assign specific network slices to managed apps on a carrier's 5G standalone network. This causes the traffic for a designated managed app to be routed to the slice identified by a specified Data Network Name. The ability to assign network slices is available through the corresponding MDM app installation and settings commands or declarative app configuration. If both network slicing and VPN are configured for an app or device, the VPN connection takes precedence over the network slice, rendering the network slice unused.

As described above, managed apps on devices with other operating systems can be associated to different network slices using the associated data network name. Though the details of the other operating systems support for 5G network slicing are not clear yet, it is possible that the following two options are feasible for associated network slices to different apps in the other operating systems. The first option is slice per app. With this option, the other operating system MDM may allow for associating network slice to an app in the UE. The second option is slice per profile. With this option, the other operating system MDM may allow associating one network slice to multiple apps if those apps have the same user/device profile. Alternatively, multiple profiles may be created in the UE (using a user's configuration), and all apps in each profile may access the same network slice.

With differential treatment to applications in different user or device profiles possible due to 5G network slicing, it is becoming possible that app developers can develop apps to take advantage of the differential treatment. Further, organizations and enterprises can configure applications in different profiles and provide enhanced network QoS to the apps in those profiles.

In an operating system, a feature called “Connected Work & Personal Apps” allows the same kind of app 506 installed in two different profiles 504. For example, Google (assistant), Android Auto and Google Calendar are some of the apps that can be installed in multiple user or device profiles 504. Similarly, more apps can be developed that can be installed in different user or device profiles 504. With Connected apps, it is possible that the same app 506 provides differential experience to end users depending on from which user or device profile 504 it was launched. For example, the calendar app launched from work profile may be offered with better network QoS with a network slice instead of the calendar app launched from the personal profile. For example, a Microsoft Teams app launched from a work profile may be offered with better network QoS with network slicing (therebefore better video and audio quality experience) compared to the Microsoft Teams app launched from the personal profile.

Although FIG. 5 illustrates an example system 500 where different networks slices are used for different user profiles, various changes may be made to FIG. 5. For example, the number and placement of various components of the system 500 can vary as needed or desired. In addition, the system 500 may be used in any other suitable multimedia process and is not limited to the specific processes described above.

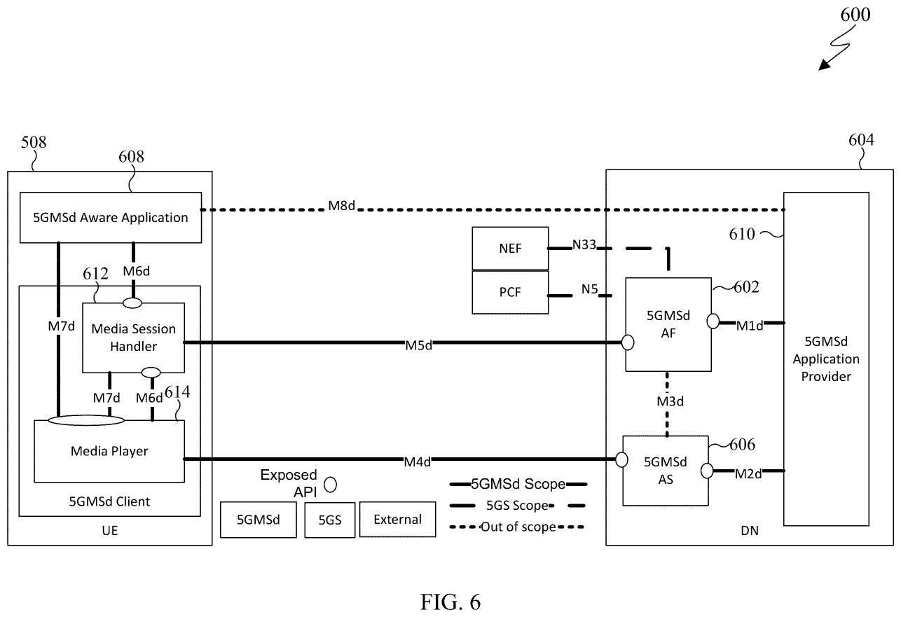

FIG. 6 illustrates an example architecture 600 for 5G media streaming in accordance with this disclosure. The embodiment of the architecture 600 illustrated in FIG. 6 is for illustration only. FIG. 6 does not limit the scope of this disclosure to any particular implementation of an electronic device.

As shown in FIG. 6, 3GPP SA WG4 is standardizing media services for deployment in 5G networks. The reference architecture 600 is for 5G Media Streaming (5GMS) as specified by 3GPP in TS 26.512. Below is a brief description of different system components for 5G Media Streaming. The 5GMSd AF 602 is an application function (AF) in the 5G core data network 604 that performs signaling functions of the application service. The 5GMSd AS 606 is an AF in the 5G core network 604 that performs media functions (e.g., media processing) for the application server. The 5GMSd aware application (AA) 608 is an application in the UE 508 (e.g., user app) that receives application service information from external 5GMSd application provider (AP) 610. The application service information is then used for retrieving information and data related to that application from the 5G core network. The media session handler is a component of the UE 508 that enables communication with signaling AF 602 in the 5G core network 604 for setting up the relevant media channels between the UE 508 and the 5G core network 604. The media player 614 is a component of the UE 508 that receives media data from media application function 606 in the 5G core network 604 and provides the data to 5GMSd AA 608, and vice versa. The signaling AF 602, the media AF 606, and the application provider 610 can be employed in either the electronic device 300 shown in FIG. 3 or the server 200 shown in FIG. 2. The AA 608, the media session handler 612, and the media player 614 can be employed by one or more processors 340 shown in FIG. 3.

As described above, 5G media streaming is enabled by setting up a couple of application functions in 5G core network 604—one that performs signaling function and another that performs media functions. There can be multiple instances of these application functions 602 and 606 the core network 604 depending upon application requirements. Different components of UE 508 connect to these application functions 602 and 606 to exchange signaling and media data to avail the 5G Media Streaming service offered by the mobile operator. With respect to using network slicing, the application provider 610 configures service provisioning information at the 5GMS AF 602 that specifies how the service should be provided to end users. Included in the service provisioning information, among a number of parameters specified in TS 26.501, are the slice configuration information and policies that are available in each of the network slices 502.

Although FIG. 6 illustrates an architecture 600 for 5G media streaming, various changes may be made to FIG. 6. For example, the number and placement of various components of the architecture 600 can vary as needed or desired. In addition, the architecture 600 may be used in any other suitable multimedia process and is not limited to the specific processes described above.

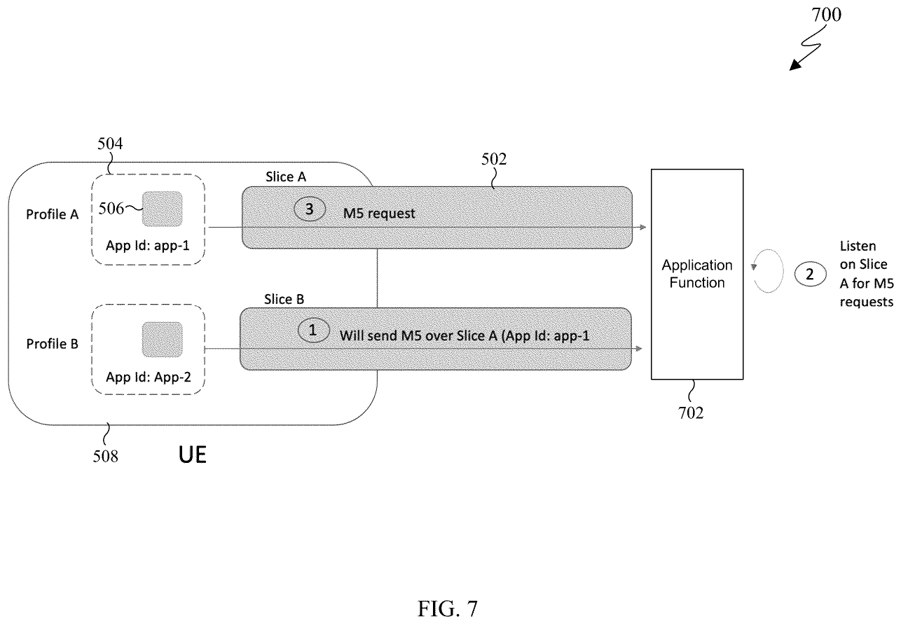

FIG. 7 illustrates an example system 700 that uses a secondary slice for outbound M5 requests in accordance with this disclosure. The embodiment of the system 700 illustrated in FIG. 7 is for illustration only. FIG. 7 does not limit the scope of this disclosure to any particular implementation of an electronic device. The AF 702 can be either the signaling AF 602 or the media AF 606.

As shown in FIG. 7, the media session handler (MSH) 612 in the UE 508 uses the M5 API to request some procedures specified in TS 26501 and TS 26512. If the 5GMS AA 608 is an app that is installed in one user or device profile 504 as described earlier in the disclosure, then the network slice 502 for the app 506 can be pre-decided or configured with a specific network slice 502. However, it is possible that the 5GMS AA 608 is an app 506 that is available in more than one user or device profiles 504, then it becomes possible that the traffic from the app 506 can be sent using different network slices 502 if multiple network slices 502 are configured for different user or device profiles 504.

To facilitate exchange of M5 between the AF 702 and MSH 612, there can be two different possibilities of setting up appropriate network slices 502 for the M5 messages. A first possibility is UE configuration, where the UE 508 or the app 506 is pre-configured so that a specific app 506, if installed in more than one user profile or device profile 504, can use one or more networks slices 502 that are available for use with the profiles 504. The second possibility is an AF configuration, where the AF 702 informs the MSH 612 using the M5 interface so that the 5GMS AA 608 can use one or either of the network slices 502 available for outbound M5 requests. For either of the above two options, the following information in Table 4 is either pre-configured or delivered from the AF 702 to the MSH 612 and then to the 5GMS AA 608.

TABLE 4

| Field | Description |
|---|---|
| Slice-preference | Information specifying which slice to use in |
| | case multiple user profiles are installed with |
| | the same application. A slice preference order |
| | in decreasing order of priority is configured/ |
| | delivery by the AF. |

To facilitate use of apps 506 in different user or device profiles 504, when the app 506 in the one user or device profile 504 receives information from the AF 702 with endpoint information, the app 506 can request that it uses a different slice 502 for outbound M5 requests. Upon receiving this information from the MSH 612, the AF 702 makes itself available in the different network slice 502 and waits to listen for messages from the app 506. When the AF 702 receives the M5 request through another network slice 502, it responds to the M5 request in the same network slice 502. However, for subsequent M5 requests, there are two options available. A first option is that the AF 702 can fallback and listen on the original network slice 502. If the MSH 612 intends to use the secondary network slice 502 again, the MSH 612 can repeat the above process. A second option is that the AF 702 can continue to listen on the secondary network slice 502. If the MSH 612 intends to use the secondary network slice 502 for additional time, it indicates in the outbound M5 message to the AF 702 with “refresh-interval”. The value of the refresh interval is in milli-seconds. If the MSH 612 includes the refresh-interval, then the AF 702 can continue to listen on the secondary network slice 502 for the refresh-interval time, and then can fall back to the original network slice 502 after that.

Although FIG. 7 illustrates an example system 700 that uses a secondary slice for outbound M5 requests, various changes may be made to FIG. 7. For example, the number and placement of various components of the system 700 can vary as needed or desired. In addition, the system 700 may be used in any other suitable multimedia process and is not limited to the specific processes described above.

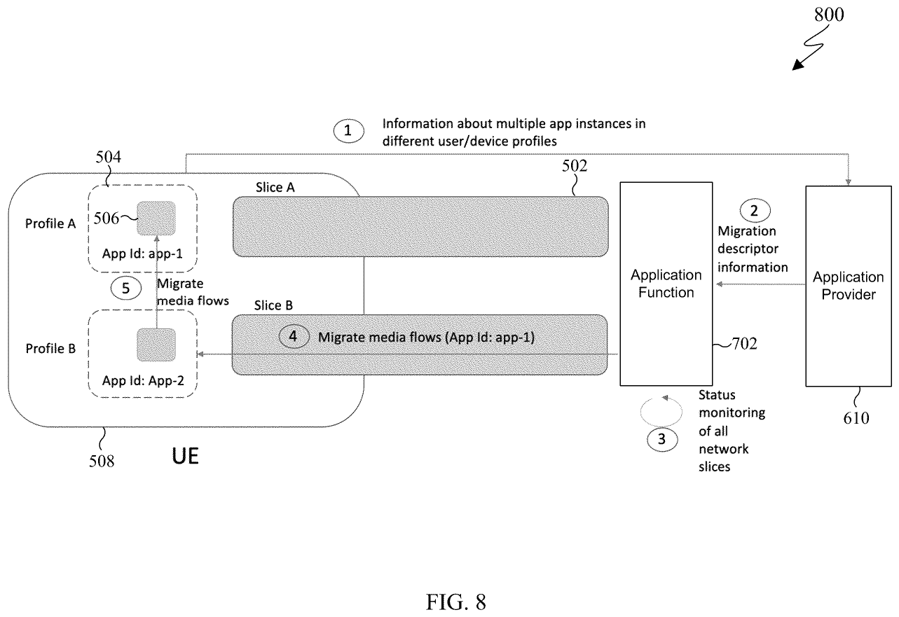

FIG. 8 illustrates an example system 800 for migration of media flow if a current network slice cannot provide sufficient QoS in accordance with this disclosure. The embodiment of the system 800 illustrated in FIG. 8 is for illustration only. FIG. 8 does not limit the scope of this disclosure to any particular implementation of an electronic device.

As shown in FIG. 8, a network slice 502, from time to time, can become congested, taken down by maintenance, or becomes unavailable, thereby not providing necessary QoS. In this case, existing application flows in different PDU Sessions in the network slice 502 can be migrated to a different network slice 502. In case of an app 506 that can be installed or accessed through more than one user or device profile 504, the media flows of the app 506 can still continue to function if the media flows can be migrated to app 506 instance in other profile 504.

To help facilitate service continuity for an app 506, the following procedure may be performed by the application provider 610 and the AF 702. The app 506 may be installed in one or more user or device profiles 504 on the UE 508, and this information is shared with the AP 610. The AP 610 can provide a service configuration to the AF 702 that in case of insufficient QoS (slice becomes unresponsive or unavailable, slice is taken down for planned maintenance etc.), the app instance in a different user/device profile 504 with a different network slice 502 may be used to migrate all the media flows from the primary slice 502 of the app 506 in the current profile 504. The AP 610 can configure the migration descriptor information at the 5GMS AF 602 indicating which app instances will be used for the service continuity procedure.

When the AF 702 receives the migration descriptor information from the AP 610, the AF 702 can continue to monitor the current status of the network slice 502 according to existing 3GPP specifications. When the performance of the current network slice 502 falls below an expected QoS, the AF 702 informs the UE MSH 612 that the media flows have to be migrated to a different network slice 502, and that a different application instance can be used for further application processing. The information from the AF 702 to the UE MSH 612 can include a list of app instances that can be used for further application related processing. In addition, the information from the AF 702 to the UE MSH 612 may also include priority information if there are multiple app instance candidates. When the UE MSH 612 can receive the information from the AF 702 about migrating the media flows from current network slice 502 to a different slice 502, the MSH 612 checks the priority information of available app instances it may be use for further application processing. The media flows are then sent using the identified app instance in a different network slice 502 to maintain service continuity.

Although FIG. 8 illustrates an example system 800 for migration of media flow if a current network slice cannot provide sufficient QoS, various changes may be made to FIG. 8. For example, the number and placement of various components of the system 800 can vary as needed or desired. In addition, the system 800 may be used in any other suitable multimedia process and is not limited to the specific processes described above.

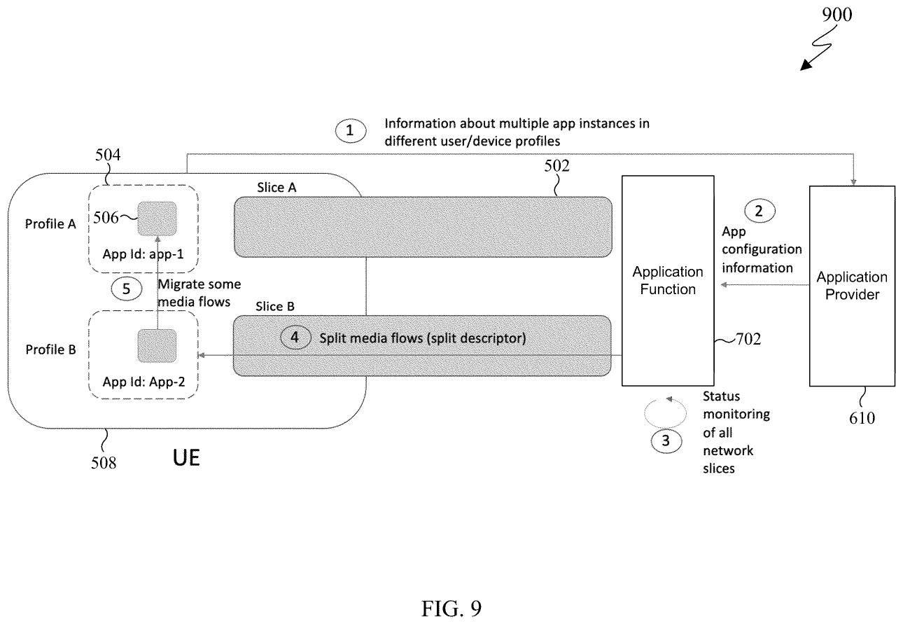

FIG. 9 illustrates an example system 900 for stream splitting between multiple app instances for service continuity in accordance with this disclosure. The embodiment of the system 900 illustrated in FIG. 9 is for illustration only. FIG. 9 does not limit the scope of this disclosure to any particular implementation of an electronic device.

As shown in FIG. 9, It is possible that due to low performance of the network slice 502 belonging to the primary app instance, the network or the UE 508 may intend to split the media component flows between the primary and secondary app instances. To facilitate the splitting of media flows, following procedure may be performed.

The app 506 may be installed in one or more user or device profiles 504 on the UE 508, and this information is shared with the AP 610. The AP 610 can provide a service configuration to the AF 702 that in case of insufficient QoS (network slice 502 becomes unresponsive or unavailable, network slice 502 is taken down for planned maintenance, etc.), the media flows in current network slice 502 being sent by the primary app instance may be split and sent through two or more app instances (in two or more network slices 502) in one or more user or device profiles 504. When the AF 702 receives the app configuration information from the AP 610, the AF 702 can continue to monitor the current status of the network slice 502 according to existing 3GPP specifications.

When the performance of the current network slice 502 falls below an expected QoS, the AF 702 can inform the UE MSH 612 that the media flows in the current network slice 502 may be split and sent through different app instances in different user or device profiles 504 by sending split descriptor information. The information in the split descriptor can includes information to split the media flows, a map of app instance IDs to media stream IDs, and a deep split map. The map of app instance IDs to media stream IDs tells the UE MSH 612 which media flow streams have to be sent through which app instances. The deep split map indicates if a component stream has to be split and sent through multiple app instances in different user or device profiles 504. Each entry in this map is a <key, value> pair where key represents the media flow stream ID that has to be split, and the value represents an object of two properties including a list of app instances through which the split streams to be sent and the criteria to be used for splitting.

When the UE MSH 612 receives the split descriptor information from the AF 702, the media flows are split based on the information in the split descriptor and sent through one or more app instances. In another embodiment, splitting of media flows can happen between multiple app instances in different user or device profiles 504. The split descriptor provides all the information necessary to split the media flows into multiple sub streams and sent through multiple app instances.

Although FIG. 9 illustrates an example system 900 for stream splitting between multiple app instances for service continuity, various changes may be made to FIG. 9. For example, the number and placement of various components of the system 900 can vary as needed or desired. In addition, the system 900 may be used in any other suitable multimedia process and is not limited to the specific processes described above.

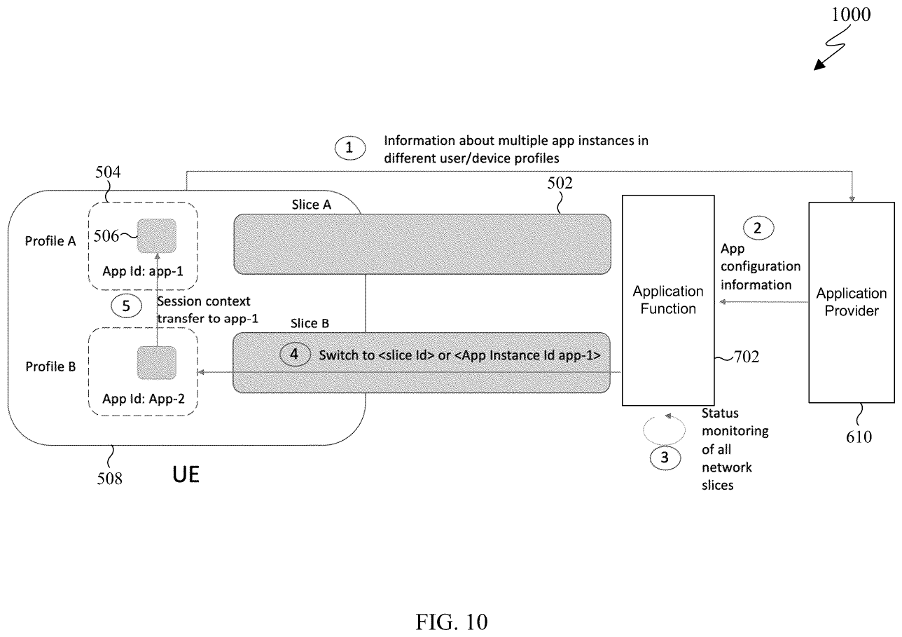

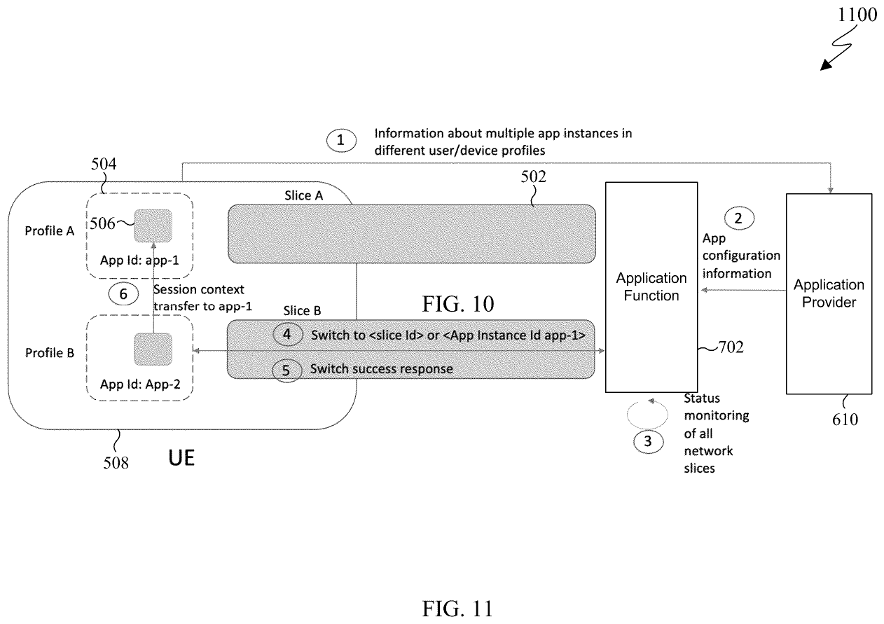

FIG. 10 illustrates an example system 1000 for network-initiated app switching in accordance with this disclosure. The embodiment of the system 1000 illustrated in FIG. 10 is for illustration only. FIG. 10 does not limit the scope of this disclosure to any particular implementation of an electronic device.

3GPP TS 26501 and TS 26512 describes methods and procedures for 5G media streaming. As described earlier in the disclosure, if different network slices 502 are assigned for transferring application traffic of apps 506 in different user or device profiles 504, and an app 506 can be installed in more than one user or device profile 504, then a recommendation from the network can be given to the UE 508 to switch the session from app 506 in one profile 504 to the same app 506 in another profile 504 based on network slice conditions.

As shown in FIG. 10, an AF 702 in the network keeps track of conditions of different network slices 502 that are associated with one or more app instances in different user or device profiles 504, then when the AF 702 sees that the current network slice 502 through which the user is engaging in the service is falling behind on service expectations, then the AF 702 can recommend the UE 508 to switch to a better network slice 502. When the UE 508 receives the recommendation from the network, UE MSH 612 may prompt the user to allow switching to alternate app instance associated with suggested network slice 502. It is up to the user to decide whether or not to follow the recommendation. Alternatively, a configuration can be made in the UE 508, or the user or device profile 504 that an automatic migration to a different network slice 502 is possible. Policies for the UE 508 in the network may also be updated and stored to facilitate automatic migration to a different app instance in a different user or device profile 504 so the new app instance may deliver better user experience.

The app 506 may be installed in one or more user or device profiles 504 on the UE 508, and this information is shared with the AP 610. The AP 610 can provide a service configuration to the AF 702 that in case of insufficient QoS (slice becomes unresponsive or unavailable, slice is taken down for planned maintenance etc.), the media streaming session may be switched to an alternate network slice 502. When the AF 702 receives the app configuration information from the AP 610, the AF 702 can continue to monitor the current status of the network slice 502 according to existing 3GPP specifications. When the performance of the current network slice 502 falls below expected QoS, the AF 702 can inform the UE MSH 612 that the current media streaming session is suffering because of network slice conditions, and provide a recommendation to switch to an alternate app instance in a different user or device profile 504 so traffic could be sent using a different network slice 502. When the performance of the current network slice 502 falls below expected QoS, the AF 702 can inform the UE MSH 612 that the current media streaming session is suffering because of network slice conditions, and provide a recommendation to switch to an alternate app instance in a different user or device profile 504 so traffic could be sent using a different network slice 502.

Although FIG. 10 illustrates example system 1000 for network-initiated app switching, various changes may be made to FIG. 10. For example, the number and placement of various components of the system 1000 can vary as needed or desired. In addition, the system 1000 may be used in any other suitable multimedia process and is not limited to the specific processes described above.

FIG. 11 illustrates an example system 1100 for UE-initiated app switching in accordance with this disclosure. The embodiment of the system 1100 illustrated in FIG. 11 is for illustration only. FIG. 11 does not limit the scope of this disclosure to any particular implementation of an electronic device.

As shown in FIG. 11, the UE 508 may initiate the app switch based on the user's perceived experience of the media service. The app 506 may be installed in one or more user or device profiles 504 on the UE 508, and this information is shared with the AP 610. Further, the user is aware that a switch request from the app 506 can be made to switch the session to an alternate app instance in a different profile 504 for better experience. The AP 610 can provide a service configuration to the AF 702 that in case of insufficient QoS (network slice 502 becomes unresponsive or unavailable, slice is taken down for planned maintenance, etc.), the media streaming session may be switched to an alternate network slice 502. When the AF 702 receives the app configuration information from the AP 610, the AF 702 continues to monitor the current status of the network slice 502 according to existing 3GPP specifications. When the performance of the media streaming session is not satisfactory to the user, the user may invoke the capability to request switching the session to an alternate app instance in a different user or device profile 504. The request is sent to the AF 702. The AF 702 can examine the request and acknowledge that the session may be switched or relocated to the alternate app instance in a different user or device profile 504. When the UE MSH 612 receives the above acknowledgement, the UE MSH 612 prompts the user that the request to migrate the session to alternate app instance in a different user or device profile 504 is accepted. If the user agrees continue, session context information may be transferred from the current app instance in current profile 504 to an alternate app instance in a different user profile 504 whose network slice 502 is performing better than the current network slice 502.

Although FIG. 11 illustrates example system 1100 for UE-initiated app switching, various changes may be made to FIG. 11. For example, the number and placement of various components of the system 1100 can vary as needed or desired. In addition, the system 1100 may be used in any other suitable multimedia process and is not limited to the specific processes described above.

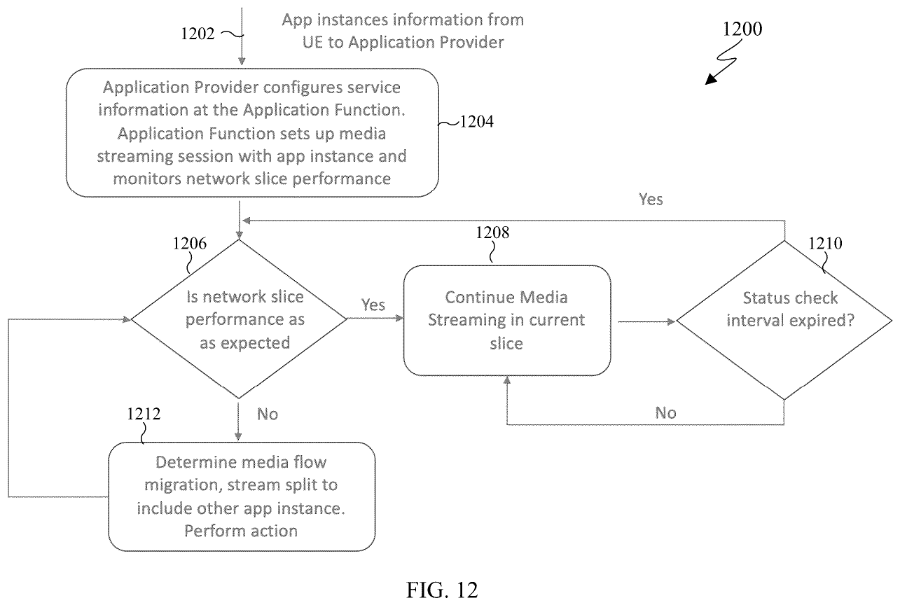

FIG. 12 illustrates an example method 1200 for optimizing the media service performance according to this disclosure. However, the method 1200 may be used with any other suitable system and any other suitable electronic device.

As shown in FIG. 12, At the UE 508, the app is installed in one or more user/device profiles at step 1202. This information is relayed to the AP 610. The UE 508 may declare the primary, and one or more secondary/backup app instances it wishes to use for the media streaming session. The UE 508 may provide a priority list of AppIds that it wishes to use in case the procedures in this disclosure are to be used.

The AP 610 can configure service information at the AF 702 at step 1204. The AF 702 can set up media streaming session with app instance in the primary profile 504 of interest of the user. Further, the AF 702 can monitor the performance of the network slice 502 through which the app 506 in the primary profile 504 sends media data.

The AF 702 can check to see if the current network slice 502 of the primary app 506 is performing as expected at step 1206. If the performance of the media service is as expected and the current network slice is performing as expected, then the AF 702 lets the media streaming session continue in the current network slice 502 that the primary app instance is using in step 1208. The AF 702 can repeat the above procedure periodically (e.g., after expiry of status check interval) in step 1210.

If the current network slice 502 that the primary app 506 is using is not performing as expected, then the AF 702 can determine the media flow migration and stream split as described in this disclosure to determine if other network slices 502 corresponding to the app instances in other user or device profiles 504 are to be used for the media streaming session in step 1212. If decision is made to perform any methods in this disclosure, the AF 702 can perform the action as described earlier to involve one or more of the secondary or backup app instances, and provide information to the UE 508 accordingly. Once the UE 508 performs the action suggested by the AF, the process can be repeated with the new setup information.

Examples of service configuration parameters that the AP 610 may configure at the 5GMS AF 602 to help with service provisioning and content ingestion are shown below in Table 5.

TABLE 5

| Field | Description |
|---|---|
| Allow-M5-secondary-slice | Boolean variable to indicate whether the UE app may use a |
| | secondary slice in other user profile for sending outbound M5 |
| | requests. Possible values: |
| | True: Indicates that the UE may use the app in other user |
| | profile to send outbound M5 requests. |
| | False: Indicates that the UE cannot use the app in other |
| | user profile to send outbound M5 requests. |
| | If the Application Provider configures this to True, the AF |
| | facilitates this configuration by providing a connection |
| | endpoint that is reachable using the secondary network slice |
| M5-secondary-slice-Ids | If the Boolean variable Allow-M5-secondary-slice is set to True, |
| | Application Provider indicates the slice identifiers of secondary |
| | slices that may send the outbound M5 requests on behalf of the |
| | primary slice. |
| | This value is a list of slice identifiers. Hence, the UE app may |
| | use one or app instances in different user/device profiles to |
| | send out the M5 requests to the 5GMS AF. |
| Allow-slice-migration | Boolean variable to indicate whether media flows from one |
| | network slice be migrated to another network slice |
| Migration-descriptor | Descriptor that provides details about migration of media flows |
| | from one slice to another. Information in this descriptor includes: |
| | Priority list of network slices that the media flows in |
| | current slice be migrated to |
| | Priority list of AppIds corresponding to different app |
| | instances that can be used to migrate the media flows from |
| | the current slice to the slice corresponding to each of the |
| | AppIds in this list |
| Migration-token | Session token that the AF passes onto the primary app instance |
| | that is to be shared with the app instance whose network slice |
| | will be used for migrating the media flows in current slice. |
| | When the secondary app instance receives the migration-token |
| | from the primary app instance, the secondary app instance will |
| | send the token to the AF. When the AF receives the migration- |
| | token from the secondary app instance, it knows the media flows |
| | of which slice were migrated to the network slice corresponding |
| | to the secondary app instance |
| Allow-stream-split | Boolean variable to indicate whether the media streams can be |
| | split into multiple sub-streams and sent through different app |
| | instances in different network slices |
| Split-descriptor | Information about how the streams be split. It includes the |
| | following information: |
| | Reason information to split the media flows |
| | Map of App instance Ids to media stream Ids - This |
| | information tells the UE MSH which media flow |
| | streams have to be sent through which app instances |
| | Deep split map - if a component stream has to be split |
| | and sent through multiple app instances in different |
| | user/device profiles. Each entry in this map is a <key, |
| | value> pair where key represents the media flow |
| | stream Id that has to be split, and the value represents |
| | an object of two properties - list of app instances |
| | through which the split streams to be sent, and the |
| | criteria to be used for splitting |
| Recommendation-switch- | Boolean variable indicating whether AF send a recommendation |
| session | to switch media streaming session from current slice to an |
| | alternate slice. Possible values: |
| | False: Cannot send or acknowledge session migration |
| | recommendation to the UE |
| | True: Can send or acknowledge session migration |
| | recommendation to the UE. |
| | If the recommendation is set to True, then AF can send a |
| | recommendation to the UE (for network initiated app switch |
| | case) or acknowledge a request from UE for migration (for |
| | app initiated switch case). AF and MSH perform the |
| | functionalities described earlier in the disclosure to migrate |
| | media streaming sessions from current app instance to |
| | alternate app instance in a different user/device profile. |

Although FIG. 12 illustrates an example method 1200 for optimizing the media service performance, various changes may be made to FIG. 12. For example, while shown as a series of steps, various steps in FIG. 12 may overlap, occur in parallel, or occur any number of times.

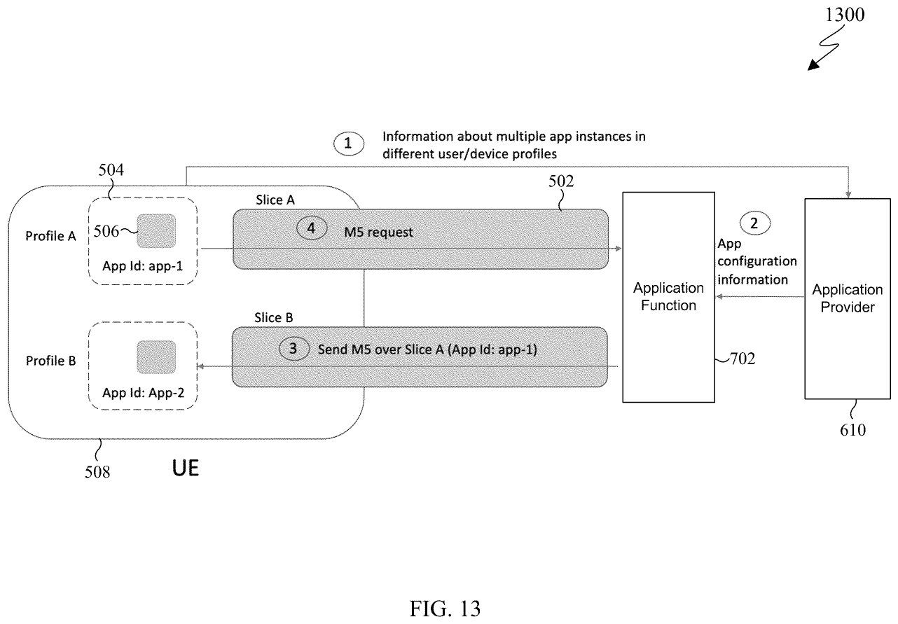

FIG. 13 illustrates an example system 1300 for use of secondary slice for outbound M5 request based on an AF recommendation in accordance with this disclosure. The embodiment of the system 1300 illustrated in FIG. 13 is for illustration only. FIG. 13 does not limit the scope of this disclosure to any particular implementation of an electronic device.

As shown in FIG. 13, the AF 702 may suggest the app 506 to use a different network slice 502 through a different user or device profile 504 to reach it, and can provide connection endpoint information to reach through the subnet of the secondary network slice 502. Presence of all the available app instances in different user or device profiles should be known to the AF 702. For this, when the app 506 can be installed in the UE 508, care should be taken care of installing the app 506 in one or more user or device profiles 504, and the information has to be relayed to the AP 610. For example, the 5GMS app developer, in conjunction with the operator and enterprise administrator may install the primary version of the app 506 in the main user or device profile 504, and back-up or secondary versions of the app 506 in one or more other user or device profiles 504 in the UE 508. When such an installation is performed, the registration of different app instances is made aware to the AP 610, and the AP 610 takes responsibility of configuring this information at the AF 702. The AF 702 is aware of this information, the AF 702 may inform the MSH 612 to move M5 requests to a different network slice 502. The AF 702 may have additional information at its behest, due to existing 3GPP specifications, about the network condition information.

Although FIG. 13 illustrates an example system 1300 for use of secondary slice for outbound M5 request based on an AF recommendation, various changes may be made to FIG. 13. For example, the number and placement of various components of the system 1300 can vary as needed or desired. In addition, the system 1300 may be used in any other suitable multimedia process and is not limited to the specific processes described above

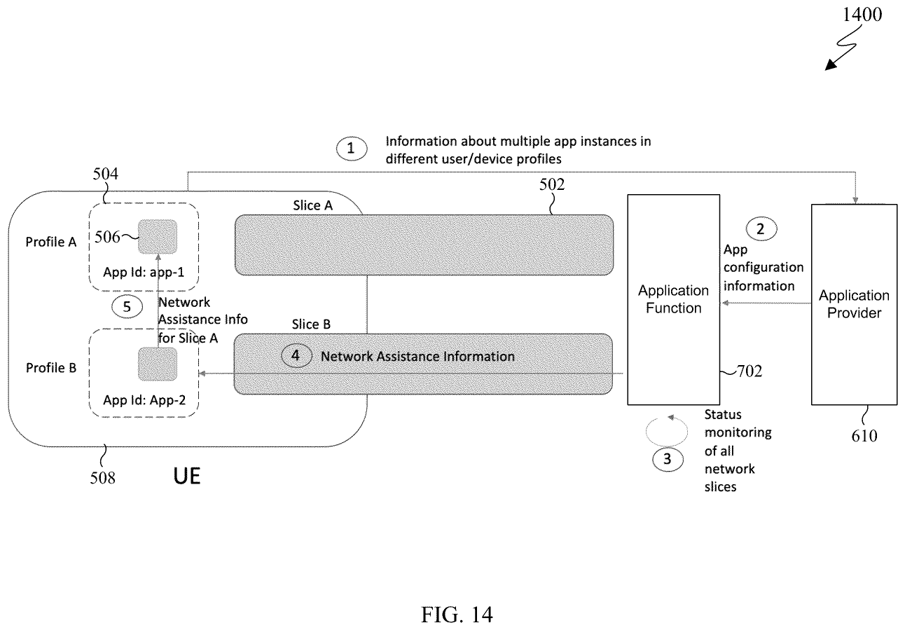

FIG. 14 illustrates an example system 1400 for network assistance information for all network slices in accordance with this disclosure. The embodiment of the system 1400 illustrated in FIG. 14 is for illustration only. FIG. 14 does not limit the scope of this disclosure to any particular implementation of an electronic device.

3GPP TS 26501 and TS 26512 describes methods for network assistance in which guidance information is shared from the AF 702 to the MSH 612 about bitrate and throughput recommendation. Earlier embodiments described network recommendation of switching media streaming session to an alternate app instance in a different user or device profile 504.

As shown in FIG. 14, the network assistance procedure specified in TS 26501 and TS 26512 may be used for such migration. With different app instances in different user or device profiles 504, it becomes possible that network assistance information from the AF 702 to the MSH 612 can be retrieved through any of the app instances accessing different network slices 502. All the app instances can share the network assistance information received from the AF 702.

Network assistance information specified in TS 26501 and TS 26512 can be sent by the AF 702 for all network slices 502 to the primary app instance. The network assistance information for each network slice 502 can then be shared between all the app instances in different user or device profiles 504. The network assistance information can then be used for migrating a media streaming session to a different app instance in a different user or device profile 504 if necessary as described in the procedures outlined in the earlier embodiments.

Although FIG. 14 illustrates an example system 1400 for network assistance information for all network slices, various changes may be made to FIG. 14. For example, the number and placement of various components of the system 1400 can vary as needed or desired. In addition, the system 1400 may be used in any other suitable multimedia process and is not limited to the specific processes described above.

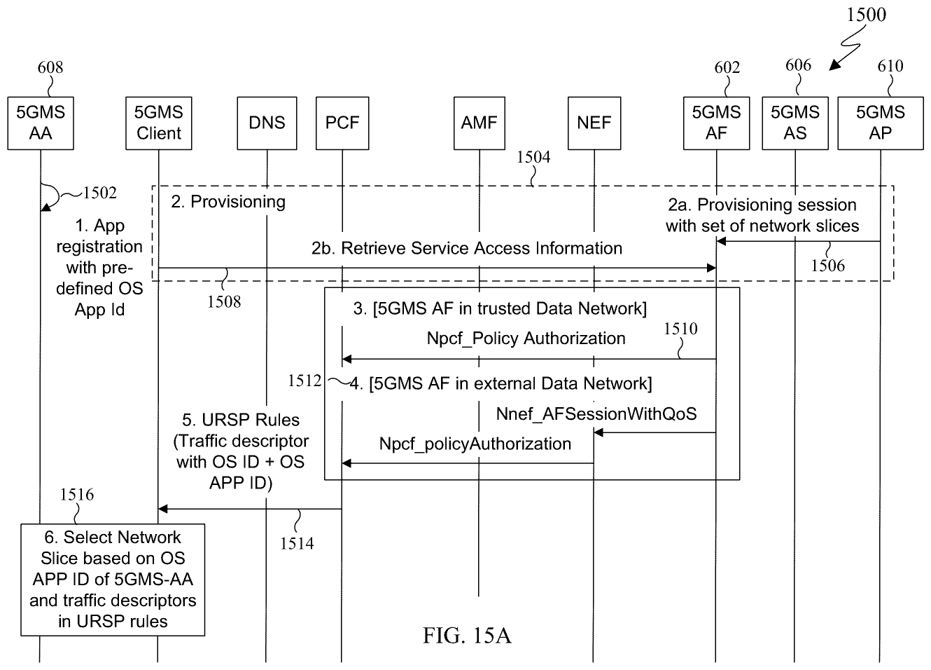

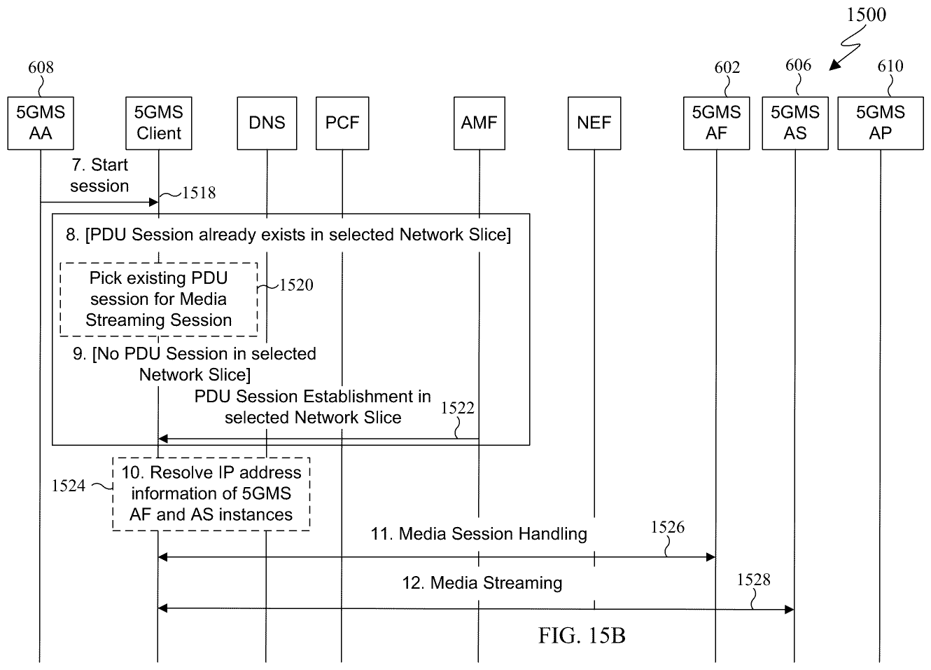

FIGS. 15A and 15B illustrate an example call flow 1500 for bootstrapping application invocation on a network slice according to this disclosure. However, the call flow 1500 may be used with any other suitable system and any other suitable electronic device.

Clause 5.15 of TS 23501 describes the concept of network slicing in 5G. Clause 6.6 of TS 23503 describes the UE policy information. As part of this policy information, specified is UE route selection policy information which contains information about traffic descriptors and a list of route selection descriptors associated with those traffic descriptors. The traffic descriptors specify components using which traffic can be identified/classified. The route selection descriptor specifies details about route selection for the identified traffic. Table 6 includes the following traffic descriptors.

TABLE 6

| Traffic descriptor | Description (as specified in TS 23503) |
|---|---|
| Application | It includes OSId and OSAppId(s). (NOTE 2) |
| descriptors | |
| IP descriptors | Destination IP 3 tuple(s) (IP address or IPv6 |
| (NOTE 5) | network prefix, port number, protocol ID of |
| | the protocol above IP). |
| Domain descriptors | FQDN(s) or a regular expression which are used |
| | as a domain name matching criteria (NOTE 6). |
| Non-IP descriptors | Descriptor(s) for destination information of |
| (NOTE 5) | non-IP traffic |
| DNN | This is matched against the DNN information |
| | provided by the application. |
| Connection | This is matched against the information provided |
| Capabilities | by a UE application when it requests a network |
| | connection with certain capabilities. (NOTE 4) |

NOTE 2:
The information is used to identify the Application(s) that is(are) running on the UE's OS. The OSId does not include an OS version number. The OSAppId does not include a version number for the application.
NOTE 4:
The format and some values of Connection Capabilities, e.g., “ims”, “mms”, “internet”, etc., are defined in TS 24.526. More than one connection capabilities value can be provided.
NOTE 5:
A URSP rule cannot contain the combination of the Traffic descriptor components IP descriptors and Non-IP descriptors.
NOTE 6:
The match of this traffic descriptor does not require successful DNS resolution of the FQDN provided by the UE Application.

Table 7 describes route selection components.

TABLE 7

| Route selection | Description |
|---|---|
| components | (as specified in TS 23503) |
| SSC Mode Selection | One single value of SSC mode. |
| | (NOTE 5) |
| Network Slice | Either a single value or a list of |
| Selection | values of S-NSSAI(s). |
| DNN Selection | Either a single value or a list of |
| | values of DNN(s). |
| PDU Session Type | One single value of PDU Session Type |
| Selection | |
| Non-Seamless Offload | Indicates if the traffic of the |
| indication | matching application is to be |
| | offloaded to non-3GPP access outside |
| | of a PDU Session. |
| ProSe Layer-3 UE-to- | Indicates if the traffic of the |
| Network Relay Offload | matching application is to be sent |
| indication | via a ProSe Layer-3 UE-to-Network |
| | Relay outside of a PDU session. |
| Access Type preference | Indicates the preferred Access Type |
| | (3GPP or non-3GPP or Multi-Access) |
| | when the UE establishes a PDU |
| | Session for the matching application. |
| PDU Session Pair ID | An indication shared by redundant |
| | PDU Sessions as described in clause |
| | 5.33.2.1 of TS 23.501. |
| RSN | The RSN as described in clause |
| | 5.33.2.1 of TS 23.501. |

NOTE 2:
At least one of the route selection components shall be present.
NOTE 3:
When the Subscription Information contains only one S-NSSAI in UDR, the PCF needs not provision the UE with S-NSSAI in the Network Slice Selection information. The “match all” URSP rule has one S-NSSAI at most.
NOTE 4:
If this indication is present in a Route Selection Descriptor, no other components shall be included in the Route Selection Descriptor.
NOTE 5:
The SSC Mode 3 shall only be used when the PDU Session Type is IP.

When the UE 508 receives information in Table 6 and Table 7 of this contribution in URSP rules, the UE 508 can use traffic detection rules in Table 6 to identify traffic, and depending on the precedence information of different route selection descriptors specified for a given traffic descriptor, applies the route selection component with highest precedence for the identified traffic.

For network slice selection, the ‘Network Slice Selection’ route selection component is useful. Theoretically, a network slice 502 can be selected for routing traffic that is identified using any of the traffic descriptor components specified in Table 6. This means, for a 5G media streaming application on the UE 508, a network slice 502 can be selected for routing traffic of this application if any of the traffic descriptor components can be specified that matches the application.

Among the different traffic descriptors, of interest in this contribution are the following traffic descriptor component types specified in Table 8.

TABLE 8
..
Traffic descriptor (octets v+5 to w)
The traffic descriptor field is of variable size and contains a variable number (at least one) of
traffic descriptor components. Each traffic descriptor component shall be encoded as a
sequence of one octet traffic descriptor component type identifier and a traffic descriptor
component value field. The traffic descriptor component type identifier shall be transmitted
first.
Traffic descriptor component type identifier
Bits
8 7 6 5 4 3 2 1
0 0 0 0 0 0 0 1 Match-all type
0 0 0 0 1 0 0 0 OS Id + OS App Id type (NOTE 1)(NOTE 3)
0 0 0 1 0 0 0 0 IPv4 remote address type
0 0 1 0 0 0 0 1 IPv6 remote address/prefix length type
..
0 1 1 1 0 0 0 0 Type of service/traffic class type
..
1 0 1 0 0 0 0 0 OS App Id type (NOTE 3)
..
..
For “OS Id + OS App Id type”, the traffic descriptor component value field shall be encoded as
a sequence of a sixteen octet OS Id field, a one octet OS App Id length field, and an OS App
Id field. The OS Id field shall be transmitted first. The OS Id field contains a Universally
Unique Identifier (UUID) as specified in IETF RFC 4122.
..
For “type of service/traffic class type”, the traffic descriptor component value field shall be
encoded as a sequence of a one octet type-of-service/traffic class field and a one octet type-of-
service/traffic class mask field. The type-of-service/traffic class field shall be transmitted first.
..
For “OS App Id type”, the traffic descriptor component value field shall be encoded as a one
octet OS App Id length field and an OS App Id field.

In certain operating systems, “Android provides support for 5G network slicing, the use of network virtualization to divide single network connections into multiple distinct virtual connections that provide different amounts of resources to different types of traffic”.

An operating system can introduce the following enterprise network slicing capabilities; which network operators can provide to their enterprise clients. Enterprise device slicing for fully-managed devices can be for enterprises who provide fully managed company devices to their employees, network providers can provide them with one or more active enterprise network slices where traffic on the company devices are routed to. From Android 12, Android allows carriers to provide enterprise slices through URSP rules, instead of setting up slices through APNs. Enterprise business app slicing for devices with work profiles can be for enterprises using a work profile solution. Android 12 allows devices to route the traffic from all apps in the work profile to an enterprise network slice. Enterprises can enable this capability through a device policy controller (DPC). The work profile solution provides an automatic level of authentication and access control that enterprises require to ensure that only traffic from enterprise apps in the work profile are routed to the enterprise network slice. Apps in the work profile don't need to be modified to explicitly request the enterprise network slice.

To support network slicing in an operating system, telephony and connectivity platform provides telephony APIs to support slicing based on 5G slicing capabilities in the modem and converts requests for slice categories into “traffic descriptors,” which are then passed to the modem for URSP traffic matching and route selection. route traffic from all apps to the corresponding connection.

A network operator, based on negotiation with the enterprise clients, sets up one or more network slices 502. Enterprise devices that are fully managed can access the network slices 502 set up for the enterprise. Alternatively, for devices setup with a work profile, the operating system can enable use of above network slices 502 for apps 506 in the work profile. The apps in the personal profile continue to use the default network slice (e.g., eMBB).

To enable 5G slicing on devices setup with a work profile, enterprise admins enable work profile app traffic routing to the enterprise network slice on a per-employee basis using the Android DevicePolicyManager (DPM) API.

Following are the slice categories supported by different operating system versions Slice categories supported by an operating system include: “ENTERPRISE”. Slice categories supported by Android 13 and higher: “ENTERPRISE”, “ENTERPRISE 2”, “ENTERPRISE 3”,“ENTERPRISE 4”, “ENTERPRISE 5”, “CBS”, “PRIORITIZE_LATENCY”, “PRIORITIZE_BANDWIDTH”. For URSP rule construction, carriers use the following operating system-specific values for OSId shown in Table 9.

TABLE 9

| ID | Value | Description |
|---|---|---|
| OSId | 97a498e3-fc92-5c94- | The OSId for Android is a |
| | 8986-0333d06e4e47 | version 5 UUID generated |
| | | with the namespace ISO OID |
| | | and the name “Android”. |

In addition, carriers must configure URSP rules for each slice traffic with the traffic descriptor component as “OS Id+OS App Id” type. For example, the “ENTERPRISE” slice must have a value of 0x97A498E3FC925C9489860333D06E4E470A454E5445525052495345. This value is a concatenation of the OSId, the length of the OSAppId (0x0A), and the OSAppId.

Management of different profiles in the operating system can be performed separately. For a device with two profiles—personal and work—When applications are installed in the operating system, they can be either installed in the personal profile, or in the work profile, or in both. When apps 506 have to be installed in both the profiles, the app 506 can be installed separately in each of the profiles 504, i.e., they are two different app instances on the same device, one in each of the profiles. Installation is supported by two different app stores, one in each of the profiles. Therefore, an application invocation is bound to a single profile, i.e., a single network context. If apps 506 in the work profile do not need to be modified to explicitly request the enterprise network slice, this means that all apps share the OS App Id because the combination of OS Id+OS App Id has to result to the same network slice selection information in the URSP rules. For this to be possible, the operating system can facilitate apps 506 to request certain network slices 502 by allowing them to register with one or more of the given OS App Ids. So, when an app 506 (example MyApp) does a registration with a given App Id (e.g., 0x454E5445525052495345 assigned for “ENTERPRISE” Network Slice), the app MyApp, given appropriate rights, will be able to access the ENTERPRISE network slice 502 that the UE 508 has access to. By doing this, all the traffic belonging to MyApp is routed through the ENTERPRISE network slice 502.

When the app 506 is installed on the UE 508, the app 506 can register with one of the supported OS App Ids of Android. Android device management makes sure that the apps 506 provide the correct OS App Id while installation and invocation.

The UE 508 can receive URSP rules as described in TS 23502. The URSP rules have the necessary traffic descriptors with a combination of OS Id+OS App Id. When application is started by the end user, application requests access to certain network slice connection. The request for slice categories is converted to traffic descriptors, which is then passed to the modem where URSP matching, and route selection takes place. The Android telephony and connectivity platform can use the route selection information to route application traffic over the selected network slice 502. All traffic related to the app 506 can be routed through the selected network slice 502. Once the network slice 502 is selected, application can use PDU Sessions in the network slice 502 for necessary operations.

Clause 5 of TS 26501 describes the high-level procedure for downlink media streaming. As part of this procedure, the 5GMS AP 610 can perform service provisioning for a 5G media streaming session at the 5GMS AF 602. The 5GMS-AA 608 may receive the service announcement Information over an M8 interface from the 5GMS AP 610 or over M5 interface from the 5GMS AF 602. When a 5G media streaming session is setup with network slicing, and if the UE 508 currently has access to more than one network slice 502, it is unclear how the 5GMS-AA 608 and the 5GMS Client on the UE 508 discover the appropriate network slice 502 to use for the session. The 5GMS-AA developer is aware of different OS App Ids supported by the UE operating system.

As shown in FIG. 15A, the 5GMS-AA 608 can installed on the UE 508, and and is programmed to invoke network connection API using pre-defined OS App Id supported by the UE operating system at step 1502. The 5GMS AP 610 can provision the media streaming session in the 5GMS AF at reference point M1 at step 1504. The 5GMS AP 610 can provision the 5G media streaming session with one or more network slices 502 at the 5GMS AF at step 1506.

The 5GMS client retrieves service access information from the 5GMS AF 602 at step 1508. Step 1508 can be performed if the 5GMS-AA 608 did not receive the complete service access information from the 5GMS AP 610 over M8. If the 5GMS AF 602 is in the trusted data network, the 5GMS AF 602 can interact directly with the PCF, using the Npcf_PolicyAuthorization service as defined in clause 5.2.5.3 of TS 23.502, to configure the QoS for the media streaming session at step 1510. Alternatively, if the 5GMS AF 602 is in the external data network, the 5GMS AF 602 may use the Nnef_AFsessionWithQoS service as defined in clause 5.2.6.9 of TS 23.502 to configure the QoS for the media streaming session at step 1512. The NEF may invoke the Npcf_PolicyAuthorization service on behalf of the 5GMS AF to configure the QoS for the media streaming session.

The PCF can constructs URSP rules and provision them in the UE 508 as described in clause 6.6.2.2 of TS 23.503 at step 1514. The URSP rules includes traffic descriptors with OS Id and OS App Id components, and corresponding route selection descriptor information with network slices 502 to use.

Based on OS App Id configured for the 5GMS-AA 608, the UE operating system enables selection of appropriate network slice 502 using the received traffic descriptor information inside URSP rules at step 1516. If multiple network slices 502 are provided for the same traffic descriptor, the precedence information in route selection descriptor is used to find the appropriate network slice 502.

As shown in FIG. 15B, the 5GMS-AA can requests a start of session to the 5GMS client at step 1518. The 5GMS client checks to see if a PDU session already exists in the selected network slice 502 at step 1520. If a PDU session already exists, 5GMS client picks the PDU Session for further interaction with media streaming endpoints. Alternatively, if no PDU Session exists in the network slice 502, the 5GMS client can create a PDU Session using the PDU Session establishment procedure specified in clause 4.3.2 of TS 23.502 at step 1522.

Once the PDU Session is available, the 5GMS client can interacts with DNS system to resolve the IP address of the 5GMS AF and AS instances at step 1524. The 5GMS client can interact with the 5GMS AF 602 for media session handling procedures described in clause 11 of TS 26512 at step 1526. The 5GMS client can interact with the 5GMS AS 606 for media streaming operations described in clause 10 of TS 26512 at step 1528.

Although FIGS. 15A and 15B illustrate an example call flow 1500 for bootstrapping application invocation on a network slice, various changes may be made to FIGS. 15A and 15B. For example, while shown as a series of steps, various steps in FIGS. 15A and 15B may overlap, occur in parallel, or occur any number of times.

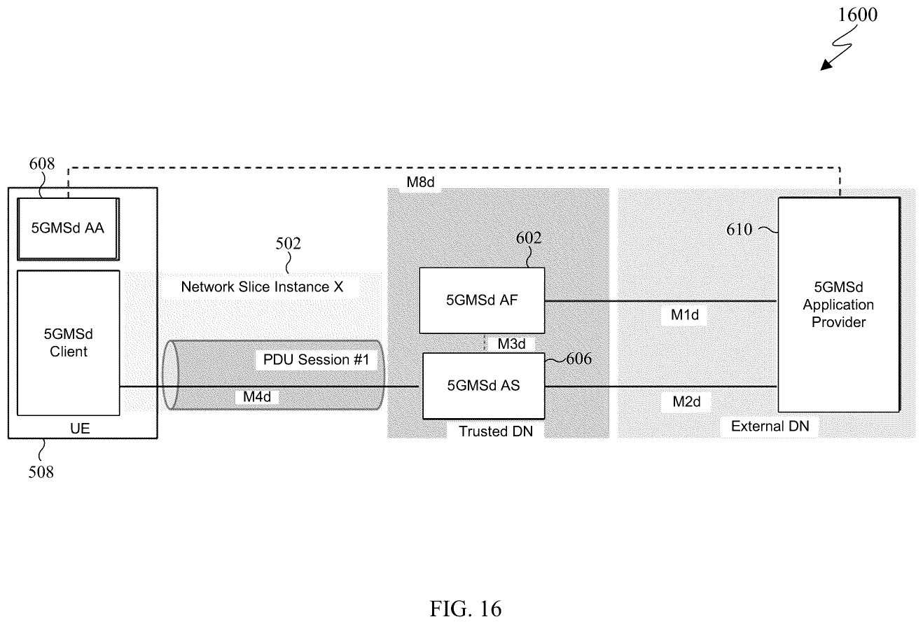

FIG. 16 illustrates an example system 1600 downlink media streaming with AF and AS in the trusted data network with network slicing in accordance with this disclosure. The embodiment of the system 1600 illustrated in FIG. 16 is for illustration only. FIG. 16 does not limit the scope of this disclosure to any particular implementation of an electronic device.

Clause 5.15.2 of TS 23501 describes the identification of network slice using NSSAI, and specifies the following:
An S-NSSAI identifies a Network Slice.
An S-NSSAI is comprised of:
   A Slice/Service type (SST), which refers to the expected Network Slice behavior in terms of features and services;
   A Slice Differentiator (SD), which is optional information that complements the Slice/Service type(s) to differentiate amongst multiple Network Slices of the same Slice/Service type.

Table 5.15.2.2-1 of TS 23501 specifies standardized SST values. Of particular interest of these three types of information is the customer information (or the tenancy information) which indicates the slice allocated to a specific customer/tenant, and the service information (to identify a service/application).

Based on the above NSSAI identification, different network slicing scenarios are possible. For example, a network slice 502 allocated for a specific customer/tenant or a network slice 502 allocated by the MNO for a specific enterprise. All applications of every UE in the enterprise use the allocated network slice. The SD field of the S-NSSAI is used to indicate the customer and tenant. Operating systems have recently started supporting 5G network slicing in mobile devices for enterprise users. Certain operating systems can support network slicing with a separate enterprise slice and slicing based on user profiles, while other operating system can support network slicing with multiple enterprise slices.

A network slice 502 can be allocated for a specific customer or tenant for a specific service or application. For example, a network slice can be allocated by the MNO for a specific enterprise and application. The application in every UE 508 in the enterprise uses the allocated enterprise network slice 502. All other apps 506 in enterprise UEs 508 can use a different (possibly default) network slice 502. The SD field of the S-NSSAI can be used to indicate the customer or tenant and the service information.

A network slice 502 can be allocated for a specific service or application. For example, a network slice 502 can be optimized for 5G media streaming. This network slice 502 can be shared between all UEs 508, specifically for a 5G media streaming application. For other applications or services, the UEs 508 can use a different (possibly default) network slice 502. The SD field of the S-NSSAI can be used to indicate the service or application. The GSMA specifies application-based network slicing, where different network slices 502 are provisioned for different apps 506.

A network slice 502 can be leased by an MNO to a virtual operator. In this case, the virtual operator leases network slice 502 from the MNO, and in turn, can offer any of the above three network slicing scenarios to its customers over the leased network slice 502.

Collaboration scenarios based on download streaming scenarios described in TS 26501. This clause presents the MNO CDN, OTT, and multi-MNO distribution collaboration scenarios described in clauses A.2, A.3, A.8, and A.9 of TS 26501 enhanced with network slicing. Other MNO CDN and OTT collaboration scenarios (clauses A.1, A.4, A.5, A.6, A.7 of TS 26501) can be similarly enhanced, and therefore not presented in this document.

As shown in FIG. 16, a collaboration scenario represents a MNO CDN collaboration scenario described in clause A.2 of TS 26501 delivered using a network slice 502. The 5GMSd AP 610 may negotiate with the MNO for creation of a network slice 502, as described in clause 4.2.2 of TR 26941. The network slice 502 can be provisioned by the network operator as described in clause 4.3 of TR 26.941.

All the interactions between all the participating entities (5GMSd AP 610, 5GMSd-AA 608, 5GMSd Client, 5GMSd AF 602, and 5GMSd AS 606) for the 5G media streaming session described in clause A.2 of TS 26.501 can apply in this scenario. All such interactions can happen through a PDU Session established within the provisioned network slice 502.

Although FIG. 16 illustrates an example system 1600 downlink media streaming with AF and AS in the trusted data network with network slicing, various changes may be made to FIG. 16. For example, the number and placement of various components of the system 1600 can vary as needed or desired. In addition, the system 1600 may be used in any other suitable multimedia process and is not limited to the specific processes described above.

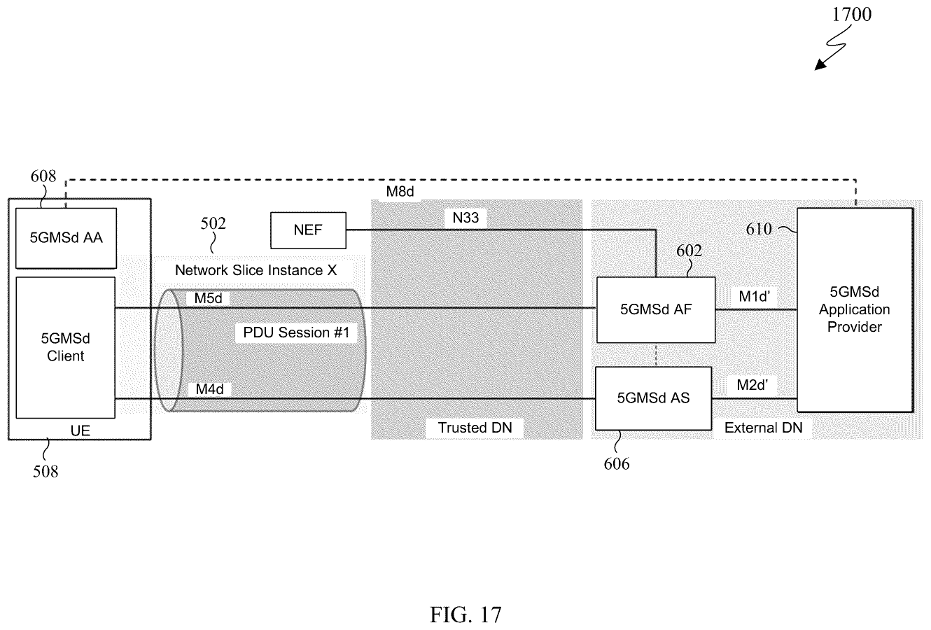

FIG. 17 illustrates an example system 1700 for downlink media streaming with AF and AS in an external data network (OTT) with network slicing in accordance with this disclosure. The embodiment of the system 1700 illustrated in FIG. 17 is for illustration only. FIG. 17 does not limit the scope of this disclosure to any particular implementation of an electronic device.

As shown in FIG. 17, a collaboration scenario represents a OTT collaboration scenario described in clause A.3 of TS 26501 delivered using a network slice 502. The 5GMSd AP 610 may negotiate with the MNO for creation of a network slice 502, as described in clause 4.2.2 of TR 26941. The network slice 502 can be provisioned by the network operator as described in clause 4.3 of TR 26.941.

All the interactions between all the participating entities (5GMSd AP 610, 5GMSd-AA 608, 5GMSd Client, 5GMSd AF 602, and 5GMSd AS 606) described in clause A.3 of TS 26.501 apply in this scenario. All such interactions can happen through a PDU Session established within the provisioned network slice 502.

Although FIG. 17 illustrates an example system 1700 for downlink media streaming with AF and AS in an external data network (OTT) with network slicing, various changes may be made to FIG. 17. For example, the number and placement of various components of the system 1700 can vary as needed or desired. In addition, the system 1700 may be used in any other suitable multimedia process and is not limited to the specific processes described above.

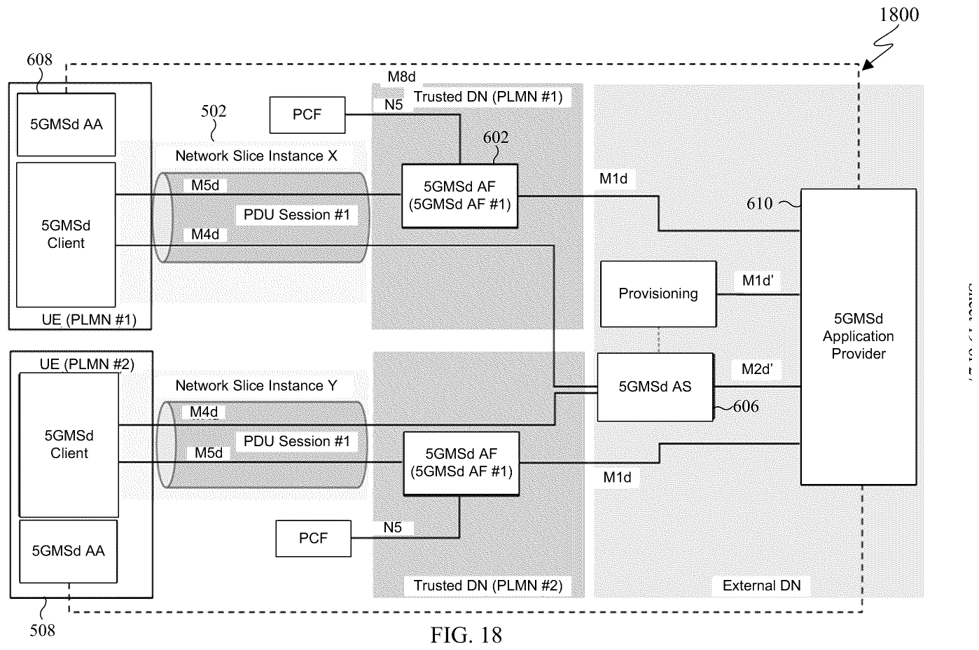

FIG. 18 illustrates an example system 1800 for downlink media streaming with AFs in two trusted data networks sharing AS in external data network with network slicing in accordance with this disclosure. The embodiment of the system 1800 illustrated in FIG. 18 is for illustration only. FIG. 18 does not limit the scope of this disclosure to any particular implementation of an electronic device.

As shown in FIG. 18, a collaboration scenario represents a multi-MNO distrobution scenario where an external CDN (5GMSd AS) is used to deliver content through multiple 5GMSd capable PLMNs described in clause A.8 of TS 26501, but delivered using a network slice 502.

The 5GMSd AP 610 may negotiate with each of the PLMNs for creation of network slices 502, as described in clause 4.2.2 of TR 26941. The network slice 502 for each PLMN is provisioned by the PLMN operator as described in clause 4.3 of TR 26.941.

All the interactions between all the participating entities (5GMSd AP 610, 5GMSd-AA 608, 5GMSd Client, 5GMSd AF 602, 5GMSd AS 606, and PCF) described in clause A.8 of TS 26.501 apply in this scenario. All such interactions can happen through PDU sessions established within the provisioned network slices 502. Each UE 508 in a different PLMN may use the provisioned network slice 502 in that PLMN for all the 5G media streaming operations. The same external CDN (5GMSd AS) serves the users of both the PLMNs, and all the signaling and media traffic is sent through PSU Sessions in respective network slices 502.

Although FIG. 18 illustrates an example system for downlink media streaming with AFs in two trusted data networks sharing AS in external data network with network slicing in accordance with this disclosure, various changes may be made to FIG. 18. For example, the number and placement of various components of the system 1800 can vary as needed or desired. In addition, the system 1800 may be used in any other suitable multimedia process and is not limited to the specific processes described above.

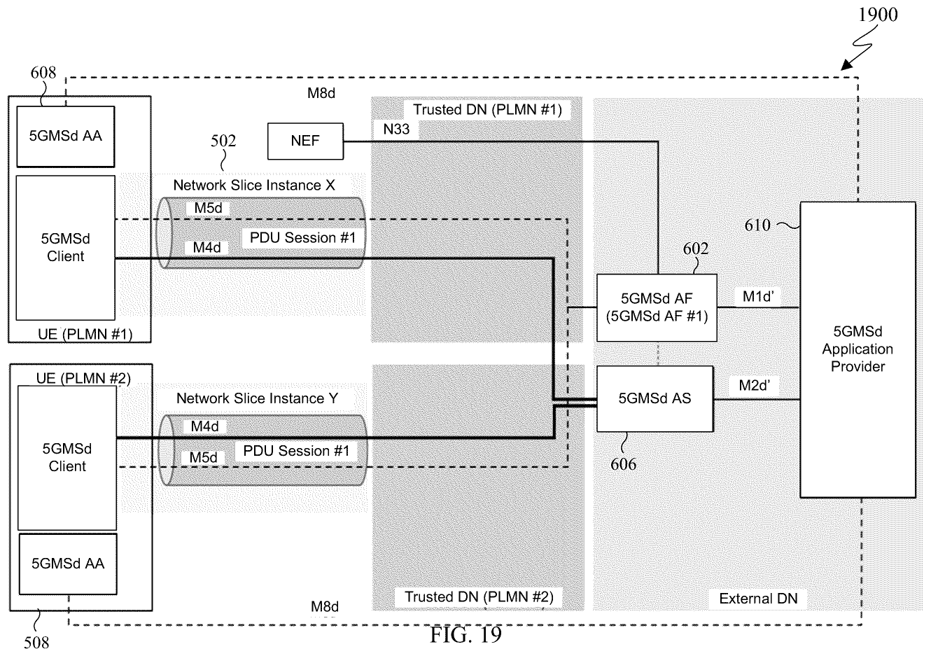

FIG. 19 illustrates an example system 1900 for downlink media streaming with AF and AS in external data network delivering through two trusted data networks (OTT) with network slicing in accordance with this disclosure. The embodiment of the system 1900 illustrated in FIG. 19 is for illustration only. FIG. 19 does not limit the scope of this disclosure to any particular implementation of an electronic device.

As shown in FIG. 19, a collaboration scenario represents a multi-MNO distribution scenario where an external CDN (5GMSd AS 606) can be used to deliver content through multiple 5GMSd capable PLMNs described in clause A.9 of TS 26501, but delivered using network slicing.

The 5GMSd AP 610 may negotiate with each of the PLMNs for creation of network slices 502 as described in clause 4.2.2 of TR 26941. The network slice 502 for each PLMN can be provisioned by the respective PLMN operator as described in clause 4.3 of TR 26.941.

All the interactions between all the participating entities (5GMSd AP 610, 5GMSd-AA 608, 5GMSd Client, 5GMSd AF 602, and 5GMSd AS 606) described in clause A.9 of TS 26.501 apply in this scenario. All such interactions can happen through PDU sessions established within the provisioned network slices 502. Each UE 508 in a different PLMN may use the provisioned network slice 502 in that PLMN for all the 5G media streaming operations. The same external CDN (5GMSd AS) and 5GMSd AF 602 serve the users of both the PLMNs, and all the signaling and media traffic is sent through PDU sessions in respective network slices 502.

Although FIG. 19 illustrates an example system 1900 for downlink media streaming with AF and AS in external data network delivering through two trusted data networks (OTT) with network slicing, various changes may be made to FIG. 19. For example, the number and placement of various components of the system 1900 can vary as needed or desired. In addition, the system 1900 may be used in any other suitable multimedia process and is not limited to the specific processes described above.

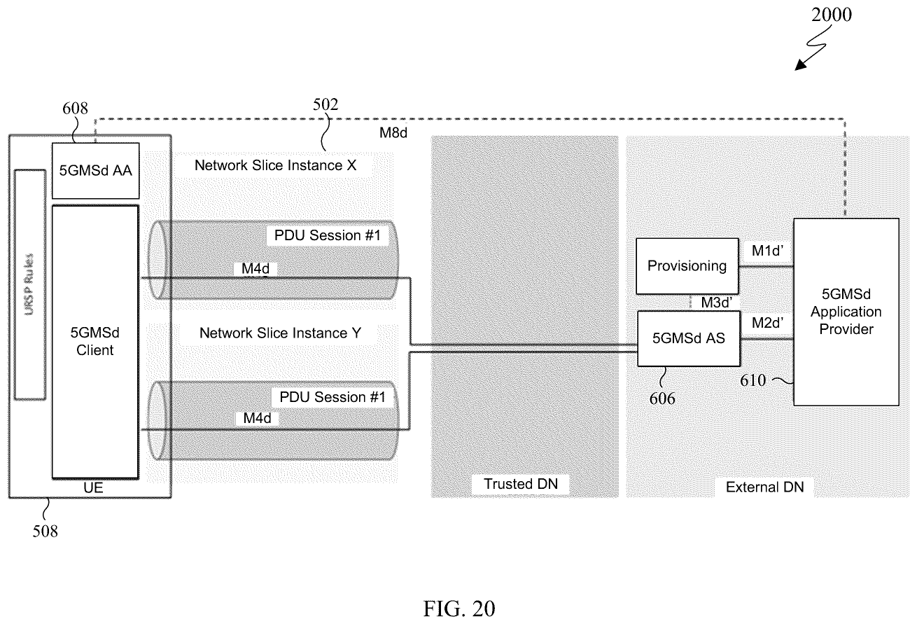

FIG. 20 illustrates an example system 2000 for downlink media streaming with AS in external data network accessible through two different network slices in accordance with this disclosure. The embodiment of the system 2000 illustrated in FIG. 20 is for illustration only. FIG. 20 does not limit the scope of this disclosure to any particular implementation of an electronic device.

As shown in FIG. 20, a collaboration scenario represents the case of accessing the same DNN through two different network slices 502. Through the DNN, an external CDN (5GMSd AS) is accessed by the UE 508. The 5GMSd AP 610 may negotiate with the MNO to setup two different network slices 502 with different SLA as described in clause 4.3 of TR 26941. After the SLA negotiation, the operator may provision two network slices 502, and provide connectivity services to the DNN through both the network slices 502.

The 5GMSd AP 610 may deliver service access information through reference point M8d. The service access information delivered to the 5GMSd-AA 608 may have information about different operation points accessible through each of the network slices 502. Upon receiving the service access information, the 5GMSd-AA 608 passes this information to the 5GMSd client. The 5GMSd client, based on input of the end user, selects the operating point of interest, and requests session setup over the network slice that provides the required operation point. Media streaming (M4d) happens through the selected network slice 502. The other network slice 502 may be used to fetch other media streaming assets (depending on criticality and SLA availability considerations), or serves as an alternate network slice in case the first slice is unavailable as discussed in clause 6.3 of TR 26941.

Although FIG. 20 illustrates an example system for downlink media streaming with AS in external data network accessible through two different network slices in accordance with this disclosure, various changes may be made to FIG. 20. For example, the number and placement of various components of the system 2000 can vary as needed or desired. In addition, the system 2000 may be used in any other suitable multimedia process and is not limited to the specific processes described above.

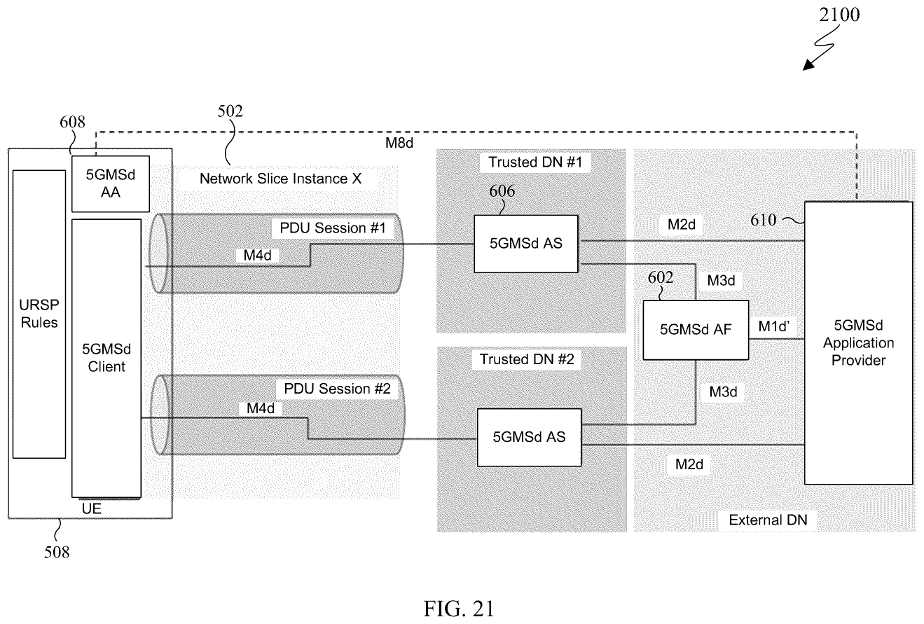

FIG. 21 illustrates an example system 2100 for downlink media streaming with AS deployed in multiple trusted data networks in accordance with this disclosure. The embodiment of the system 2100 illustrated in FIG. 21 is for illustration only. FIG. 21 does not limit the scope of this disclosure to any particular implementation of an electronic device.

As shown in FIG. 21, a collaboration scenario represents the case of accessing two different data networks using the same network slice 502 as shown in FIG. 4.2.1-1 of TR 26941. A CDN server (5GMSd AS 606) can either be setup in each of the trusted data networks, or has a multi homing interface through each of the trusted date networks.

The 5GMSd AP 610 may negotiate with the MNO to setup a network slice 502 as described in clause 4.3 of TR 26941. The operator provisions the network slice 502 and provides connectivity services to both the DNs through the network slice 502.

The 5GMSd AP 610 may deliver service access information through reference point M8d. The service access information delivered to the 5GMSd-AA 608 may have information about different operation points accessible through each of the DNs. For example, an enterprise may utilize an enterprise specific CDN (e.g., hosting enterprise related video tutorials). 5G media streaming requests from the 5GMSd client for enterprise related video tutorials use the PDU session terminating in the enterprise specific CDN, while some other video tutorial requests are sent through PDU sessions terminating in a different CDN. Alternatively, a DN may act as a back up CDN, and utilized by the 5GMSd Client if the primary CDN is inaccessible or unavailable for any reason. In another scenario, the second CDN may be a CDN edge with optional media processing.

Although FIG. 21 illustrates an example system 2100 for downlink media streaming with AS deployed in multiple trusted data networks, various changes may be made to FIG. 21. For example, the number and placement of various components of the system 2100 can vary as needed or desired. In addition, the system 2100 may be used in any other suitable multimedia process and is not limited to the specific processes described above.

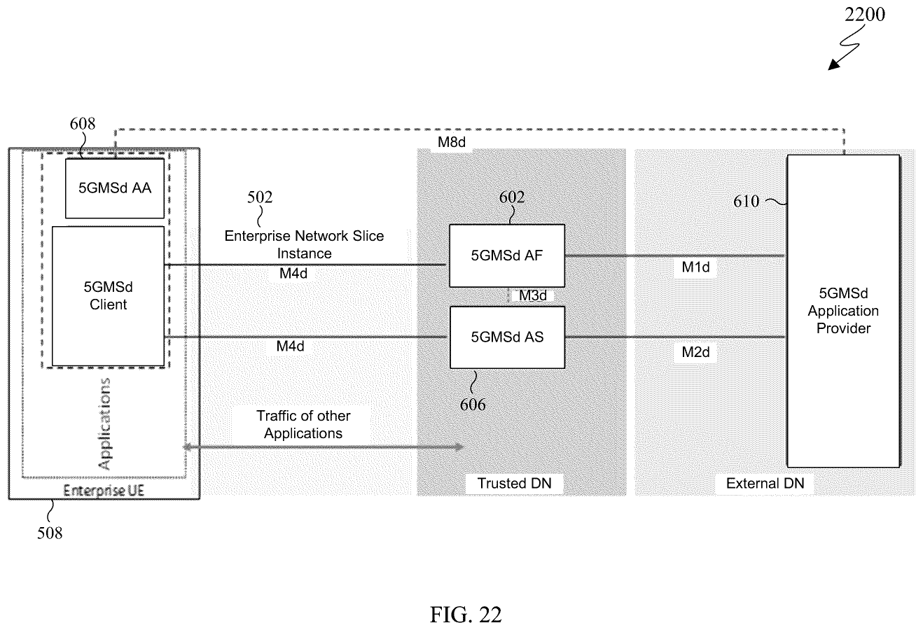

FIG. 22 illustrates an example system 2200 using a network slice for all application in the enterprise UE in accordance with this disclosure. The embodiment of the system 2200 illustrated in FIG. 22 is for illustration only. FIG. 22 does not limit the scope of this disclosure to any particular implementation of an electronic device.

Scenarios described in this clause are based on the MNO CDN collaboration scenario described in clause A.7 of TS 26501, where in both the 5GMSd AF 602 and 5GMSd AS 606 are in the trusted DN, and the 5GMSd AP 610 uses M1d and M2d to interact with them respectively. However, all the collaboration scenarios described in clause A of TS 26501 can be similarly shown with each of the network slicing scenarios described in this clause.

As shown in FIG. 22, a network slicing scenario where in the MNO, upon a request from an enterprise, allocates one or more network slices 502 exclusively for enterprise users. the case of an enterprise network slice 502 for all applications in the enterprise UE 508. Every app 506 on the enterprise UE 508, including the 5G media streaming application, uses the allocated network slice 502 for communication with the DN entities. Certain operating systems support network slicing with a separate enterprise network slice 502 allocated by the MNO.

Although FIG. 22 illustrates an example system using a network slice for all application in the enterprise UE in accordance with this disclosure, various changes may be made to FIG. 22. For example, the number and placement of various components of the system 2200 can vary as needed or desired. In addition, the system 2200 may be used in any other suitable multimedia process and is not limited to the specific processes described above.

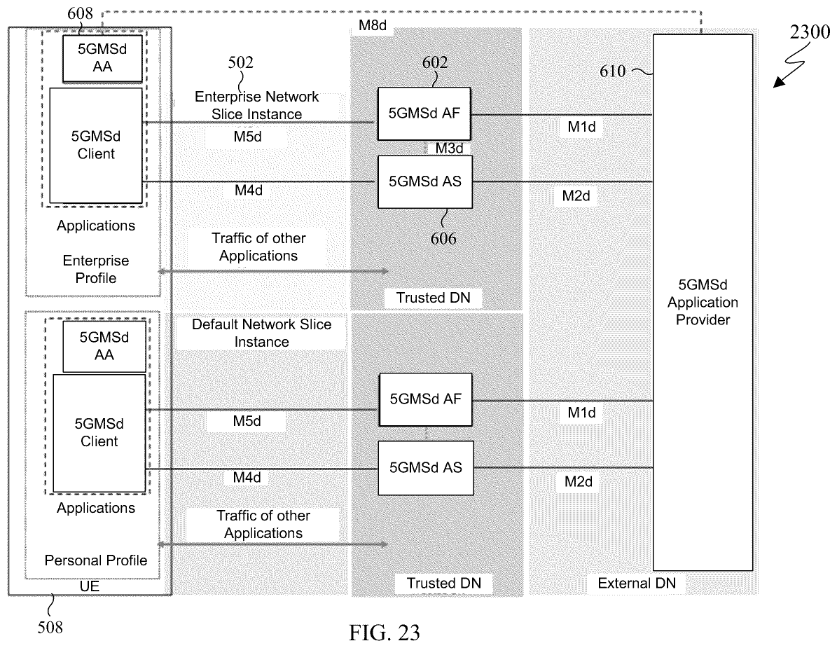

FIG. 23 illustrates an example system 2300 using a network slice for enterprise profile applications in accordance with this disclosure. The embodiment of the system 2300 illustrated in FIG. 23 is for illustration only. FIG. 23 does not limit the scope of this disclosure to any particular implementation of an electronic device.

As shown in FIG. 23, an enterprise network slice 502 for can be used for applications in the enterprise profile of the UE 508. Every app 506 in the enterprise and work profile 504 of the UE 508, including the 5G media streaming application, uses the allocated enterprise network slice 502 for communication with the DN entities. Every app 506 in the non-enterprise profile of the UE 508 (e.g., personal profile), including the 5G media streaming application, uses the default (e.g., eMBB) network slice 502 for communication with the DN entities. Certain operating systems can support network slicing with multiple enterprise network slices 502, and slicing based on user profiles 504.

Although FIG. 23 illustrates an example system 2300 using a network slice for enterprise profile applications, various changes may be made to FIG. 23. For example, the number and placement of various components of the system 2300 can vary as needed or desired. In addition, the system 2300 may be used in any other suitable multimedia process and is not limited to the specific processes described above.

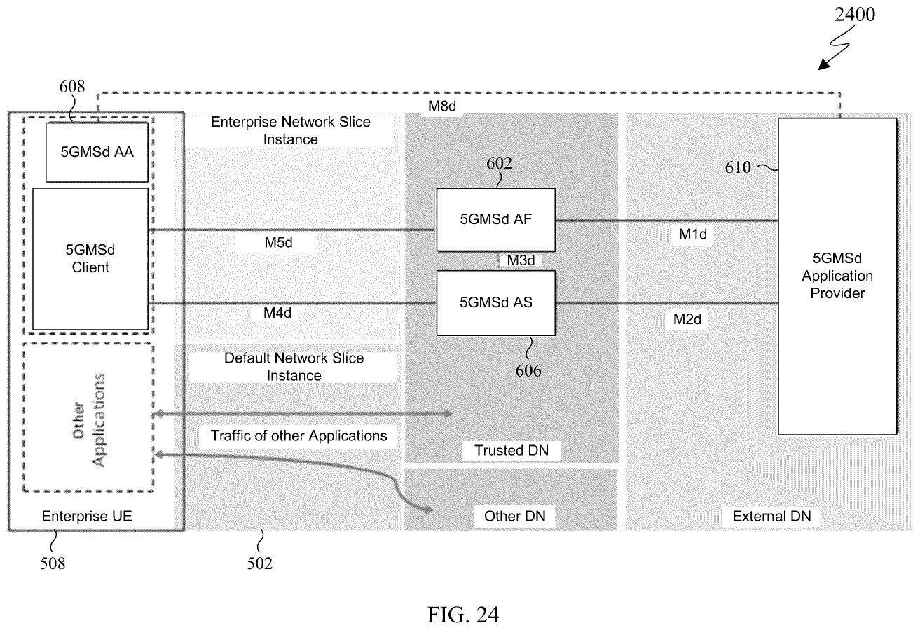

FIG. 24 illustrates an example system 2400 using a network slice for specific applications for enterprise users in accordance with this disclosure. The embodiment of the system 2400 illustrated in FIG. 24 is for illustration only. FIG. 24 does not limit the scope of this disclosure to any particular implementation of an electronic device.

As shown in FIG. 24, a network slicing scenario where the MNO, upon a request from an enterprise, allocates a specific network slice 502 for a specific service or application for enterprise users. An enterprise network slice 502 can be used for a specific application (e.g., 5G Media Streaming application) for enterprise UEs 508. The traffic belonging to the 5G media streaming application is sent through the enterprise network slice 502, while the traffic of all other apps 506 is sent through a default network slice 502. URSP rules, provisioned by the PCF, as described in clause 6.6.2.2 of TS 23.503, can assist in traffic detection and route selection of appropriate network slice for application traffic in the UE 508.

Although FIG. 24 illustrates an example system 2400 using a network slice for specific applications for enterprise users in accordance with this disclosure, various changes may be made to FIG. 24. For example, the number and placement of various components of the system 2400 can vary as needed or desired. In addition, the system 2400 may be used in any other suitable multimedia process and is not limited to the specific processes described above.

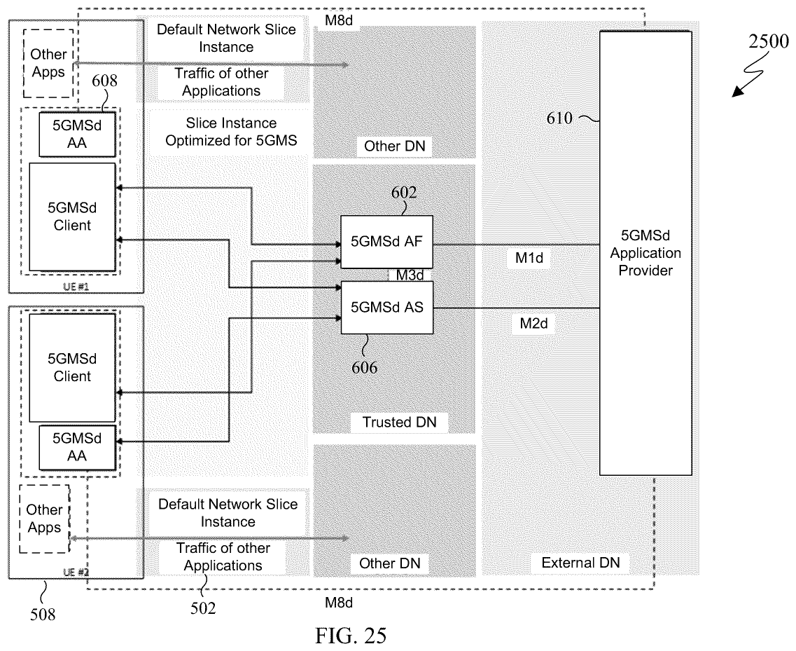

FIG. 25 illustrates an example system 2500 using a network slice for specific applications for all users in accordance with this disclosure. The embodiment of the system 2500 illustrated in FIG. 25 is for illustration only. FIG. 25 does not limit the scope of this disclosure to any particular implementation of an electronic device.

As shown in FIG. 25, a network slicing scenario can be used where in the MNO allocates a specific network slice 502 for a specific service or application for all users. The MNO may provision more specific network slices 502 for carrying traffic of other specific applications. A network slice 502 can be optimized for a specific application (e.g., 5G media streaming application). The traffic belonging to the 5G media streaming application of all users can be sent through a network slice 502 optimized for 5G media streaming, while the traffic of all other applications is sent through a default network slice 502. URSP rules, provisioned by the PCF, as described in clause 6.6.2.2 of TS 23.503, can assist in traffic detection and route selection of appropriate network slice for application traffic in the UE 508.

This is a network slicing scenario where in virtual operator leases network slice 502 from the MNO and uses the network slice 502 to provide service to its customers as described in clause 5.2.2 of TR 26941. A virtual operator may in turn offer any of the above three slicing scenarios on the leased network slice 502.

Described earlier in the disclosure is a method where in the UE app registers with a given OSAppId to access certain network slice 502. The OSAPPIds are shared with the network operator, so the operator knows how to handle application traffic using a particular network slice 502. In addition, the OS on the mobile device knows that the traffic from a given application, since the app registers with a given OSAPPId, knows how to route application traffic over that specific network slice 502.

To enhance the functionality of an app 506 for slice selection, the following information in Table 10 may be provided by the app 506 to the UE OS. This information defines the slice descriptor information that the UE app provides to the UE OS for routing application traffic over certain network slices 502.

TABLE 10

| Information Element | |
|---|---|
| in Slice Descriptor | Description |
| primary-OSAppId | The OSAppId that the UE app registers to. The |
| | OSAppId is shared with the network operator, |
| | so the UE OS and network operator knows |
| | how to provide traffic treatment to the |
| | application traffic over that network slice |
| Priority-list-OSAppIds | A priority list of OSAppIds that the UE app |
| | registers to. If the OSAppId of the highest |
| | priority is unavailable, i.e., the network slice |
| | corresponds to that OSAppId is unavailable, |
| | the OSAppId with next highest priority should |
| | be used for routing application traffic |
| | When the UE OS receives this information, it |
| | checks to see if the OSAppId if highest priority |
| | is available currently. If yes, then the |
| | application traffic is routed over corresponding |
| | network slice. |
| | Alternatively, if the OSAppId corresponding to |
| | the highest priority is unavailable, UE OS uses |
| | the OSAppId with next highest priority to route |
| | application traffic. |
| | This information element is provided by the |
| | UE if all application streams go through the |
| | same network slice |
| Replacement-OSAppId | This indicates the network slice that is to be |
| | used if the network decides to replace the |
| | network slice associated with the primary- |
| | OSAppId |
| | This information element corresponds to the |
| | case when all the application streams were |
| | initially routed over the primary-OSAppId |
| Stream-array-OSAppIds | Array of OSAppIds if the app intends to send |
| | its streams over multiple network slices. |
| | Example, the app may send one stream traffic |
| | over PRIORITIZE_LATENCY network slice, |
| | and another stream over |
| | PRIORITIZE_BANDWIDTH network slice |
| | When this information is provided by the app, |
| | the UE OS makes available the list of |
| | OSAppIds in this array to the UE app. The UE |
| | app may then send streams in network slices |
| | corresponding to different OSAppIds in this |
| | array. |
| | For this to work, the UE app may negotiate |
| | with the Application Provider, and the |
| | Application Provider configures this |
| | information at the Application Function in the |
| | operator network. Alternatively, the UE app, |
| | may use Media Session Handler in the UE, to |
| | communicate directly with the Application |
| | Function, example using the M5 interface |
| | specified in TS 26501. In this way, the |
| | network, via Application Function, and the UE |
| | and the UE OS are in synchronization on how |
| | to use multiple network slices for sending |
| | different streams of the UE application. |
| | The UE, over the course of the service/session, |
| | may add more streams for the application. For |
| | example, the UE app may decide to uplink |
| | stream a 4K video in addition to HD video. In |
| | this case, the UE updates this stream array to |
| | add one more OSAppId to route 4K traffic. |
| | The UE app may choose an appropriate |
| | OSAppId for the newly added stream. The UE |
| | app updates the Application Function, via the |
| | Application Provider, about the newly added |
| | stream, and the network slice it intends to use |
| | for routing that new stream. Alternatively, the |
| | UE app, may use Media Session Handler in the |
| | UE, to communicate directly with the |
| | Application Function, example using the M5 |
| | interface specified in TS 26501 for updating |
| | the Application Function with information |
| | about newly added stream and the network |
| | slice the UE app intends to use for routing the |
| | respective stream |
| Map-stream-replacement-OSAppIds | Map of replacement OS-AppIds if the network |
| | intends to perform network slice replacement, |
| | and the UE may provide its preference to the |
| | network. |
| | Each entry in the map is a key -value pair, |
| | where in the key represents the OSAppId given |
| | in Stream-array-OSAppId, the value |
| | corresponds to the OSAppId that should be |
| | used if the network decides to perform network |
| | slice replacement |

Although FIG. 25 illustrates an example system 2500 using a network slice for specific applications for all users in accordance with this disclosure, various changes may be made to FIG. 25. For example, the number and placement of various components of the system 2500 can vary as needed or desired. In addition, the system 2500 may be used in any other suitable multimedia process and is not limited to the specific processes described above.

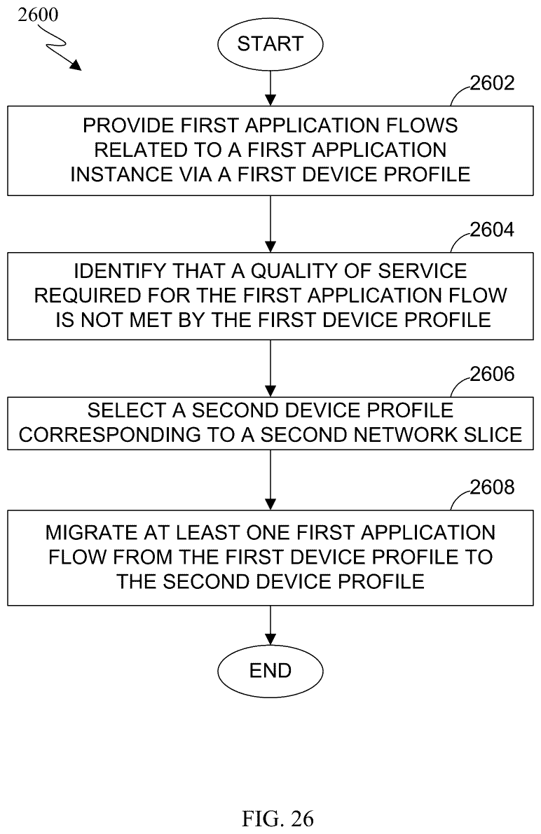

FIG. 26 illustrates an example method 2600 for media services with network slicing and user and device profiles according to this disclosure. However, the method 2600 may be used with any other suitable system and any other suitable electronic device.

As shown in FIG. 26, the electronic device 300 can provide first application flows related to a first application instance via a first device profile at step 2602. The first device profile can correspond to a first network slice. An application function or user equipment can provide first application flows related to a first application instance via a first device profile.

The electronic device 300 can identify that a quality of service required for the first application flow is not met by the first device profile at step 2604. The application function or user equipment can identify that a quality of service (QOS) required for the first application flows is not met by the first device profile.

In certain embodiments, the electronic device 300 can receive first information related to a first device profile, where the first information includes information related to the first application instance present in the first device profile and capabilities of the first application instance present in the first device profile. The electronic device 300 can second information related to the second device profile, where the second information includes information related to the second application instance present in the second device profile and capabilities of the second application instance present in the second device profile.

The electronic device 300 can select a second device profile corresponding to a second network slice at step 2606. The application function or user device can select a second device profile corresponding to a second network slice. The selection of the second device profile can be in response to identifying that the QoS required for the first application flows is not met. The selection of the second device profile can be based on (i) a capability of the second device profile to provide the QoS required for the first application flows and (ii) a presence of a second application instance corresponding to the first application instance.

The electronic device 300 can migrate at least one first application flow from the first device profile to the second device profile at step 2608. The application function can migrate at least one first application flow from the first device profile to the second device profile. The user equipment can transmit a message to an application function to migrate at least one of the first application flows from the first device profile to the second device profile. In certain embodiments, all of the first application flow are migrated from the first device profile to the second device profile. In certain embodiments, at least a second of the first application flows are provided using the first device profile.

The at least one of the first application flows from the first device profile migrated to the second device profile that is providing at least a portion of second application flows corresponding to the second application instance can be provided via the second network slice.

In certain embodiments, to migrate the at least one of the first application flows from the first device includes the electronic device 300 invoking the second application instance in the second device profile. The electronic device 300 can provide second application flows corresponding to the second application instance via the second network slice.

In certain embodiments, the electronic device 300 can determine whether the second application flows provided via the second network slice meet a QoS required for the second application flows. In response to determining that the second application flows provided via the second network slice does not meet the QoS required for the second application flows, the electronic device 300 can select a third network slice based on a slice preference order. The slice preference order can identify a list of slices in an order of preference. The electronic device 300 can migrate at least one of the second application flows to the third network slice.

Although FIG. 26 illustrates an example method for media services with network slicing and user and device profiles, various changes may be made to FIG. 26. For example, while shown as a series of steps, various steps in FIG. 26 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for an application function comprising:
providing first application flows related to a first application instance via a first device profile, wherein the first device profile corresponds to a first network slice;
identifying that a quality of service (QOS) required for the first application flows is not met by the first device profile;
in response to identifying that the QoS required for the first application flows is not met, selecting a second device profile corresponding to a second network slice based on (i) a capability of the second device profile to provide the QoS required for the first application flows and (ii) a presence of a second application instance corresponding to the first application instance; and
migrating at least one of the first application flows from the first device profile to the second device profile.

2. The method of claim 1, wherein all of the first application flows are migrated from the first device profile to the second device profile.

3. The method of claim 1, wherein at least a second of the first application flows are provided using the first device profile.

4. The method of claim 1, further comprising:
receiving first information related to the first device profile; and
receiving second information related to the second device profile,
wherein the first information includes information related to the first application instance present in the first device profile and capabilities of the first application instance present in the first device profile,
wherein the second information includes information related to the second application instance present in the second device profile and capabilities of the second application instance present in the second device profile, and
wherein migrating the at least one of the first application flows from the first device profile to the second device profile comprises migrating the at least one of the first application flows from the first device profile to the second device profile that is providing at least a portion of second application flows corresponding to the second application instance provided via the second network slice.

5. The method of claim 1, wherein migrating the at least one of the first application flows from the first device profile to the second device profile comprises:
invoking the second application instance in the second device profile, and
providing second application flows corresponding to the second application instance via the second network slice.

6. The method of claim 5, further comprising:
determining whether the second application flows provided via the second network slice meet a QoS required for the second application flows; and
in response to determining that the second application flows provided via the second network slice does not meet the QoS required for the second application flows, selecting a third network slice based on a slice preference order,
wherein the slice preference order identifies a list of slices in an order of preference.

7. The method of claim 6, further comprising:
migrating at least one of the second application flows to the third network slice.

8. An application function comprising:
a transceiver; and
a processor configured to:
provide first application flows related to a first application instance via a first device profile, wherein the first device profile corresponds to a first network slice;
identify that a quality of service (QOS) required for the first application flows is not met by the first network slice;
in response to identifying that the QoS required for the first application flows is not met, select a second device profile corresponding to a second network slice based on (i) a capability of the second device profile to provide the QoS required for the first application flows and (ii) a presence of a second application instance corresponding to the first application instance; and
migrate at least one of the first application flows from the first device profile to the second device profile.

9. The application function of claim 8, wherein all of the first application flows are migrated from the first device profile to the second device profile.

10. The application function of claim 8, wherein at least a second of the first application flows are provided using the first device profile.

11. The application function of claim 8, wherein the processor is further configured to:
receive first information related to the first device profile; and
receive second information related to the second device profile,
wherein the first information includes information related to the first application instance present in the first device profile and capabilities of the first application instance present in the first device profile,
wherein the second information includes information related to the second application instance present in the second device profile and capabilities of the second application instance present in the second device profile, and
wherein, to migrate the at least one of the first application flows from the first device profile to the second device profile, the processor is configured to migrate the at least one of the first application flows from the first device profile to the second device profile that is providing at least a portion of second application flows corresponding to the second application instance provided via the second network slice.

12. The application function of claim 8, wherein, to migrate the at least one of the first application flows from the first device profile to the second device profile, the processor is configured to:
invoke the second application instance in the second device profile, and
provide second application flows corresponding to the second application instance via the second network slice.

13. The application function of claim 12, wherein the processor is further configured to:
determine whether the second application flows provided via the second network slice meet a QoS required for the second application flows; and
in response to determining that the second application flows provided via the second network slice does not meet the QoS required for the second application flows, select a third network slice based on a slice preference order,
wherein the slice preference order identifies a list of slices in an order of preference.

14. The application function of claim 13, wherein the processor is further configured to:
migrate at least one of the second application flows to the third network slice.

15. A user equipment comprising:
a transceiver; and
a processor configured to:
provide first application flows related to a first application instance via a first device profile, wherein the first device profile corresponds to a first network slice,
identify that a quality of service (QOS) required for the first application flows is not met by the first device profile;
in response to identifying that the QoS required for the first application flows is not met, select a second device profile corresponding to a second network slice based on (i) a capability of the second device profile to provide the QoS required for the first application flows and (ii) a presence of a second application instance corresponding to the first application instance; and
transmit a message to an application function to migrate at least one of the first application flows from the first device profile to the second device profile.

16. The user equipment of claim 15, wherein all of the first application flows are migrated from the first device profile to the second device profile.

17. The user equipment of claim 15, wherein at least a second of the first application flows are provided using the first device profile.

18. The user equipment of claim 15, wherein the processor is further configured to:
identify first information related to the first device profile; and
identify second information related to the second device profile,
wherein the first information includes information related to the first application instance present in the first device profile and capabilities of the first application instance present in the first device profile,
wherein the second information includes information related to the second application instance present in the second device profile and capabilities of the second application instance present in the second device profile, and
wherein, to transmit a message to the application function to migrate the at least one of the first application flows from the first device profile to the second device profile, the processor is configured to, transmit a message to the application function to migrate the at least one of the first application flows from the first device profile to the second device profile that is providing at least a portion of second application flows corresponding to the second application instance provided via the second network slice.

19. The user equipment of claim 15, wherein, to transmit a message to the application function to migrate the at least one of the first application flows from the first device profile to the second device profile, the processor is configured to:
transmit a message to the application function to invoke the second application instance in the second device profile, and
transmit a message to the application function to provide second application flows corresponding to the second application instance via the second network slice.

20. The user equipment of claim 19, wherein the processor is further configured to:
determine whether the second application flows provided via the second network slice meet a QoS required for the second application flows; and
in response to determining that the second application flows provided via the second network slice does not meet the QoS required for the second application flows, select a third network slice based on a slice preference order,
wherein the slice preference order identifies a list of slices in an order of preference.
